(19) United States
(12) Patent Application Publication
(10) Pub. No.: US 2017/0172147 A1
(43) Pub. Date: Jun. 22, 2017

(54) BIO-INSPIRED AND ANTIMICROBIAL POLYMERS CONTAINING AMINO ACID-LIKE MONOMER BUILDING BLOCKS

(71) Applicants: Abraham Joy, Copley, OH (US); Steven Mankoci, Cuyahoga Falls, OH (US); Elaheh A. Chamsaz, Fairlawn, OH (US)

(72) Inventors: Abraham Joy, Copley, OH (US); Steven Mankoci, Cuyahoga Falls, OH (US); Elaheh A. Chamsaz, Fairlawn, OH (US)

(21) Appl. No.: 15/383,144

(22) Filed: Dec. 19, 2016

Related U.S. Application Data
(60) Provisional application No. 62/269,150, filed on Dec. 18, 2015.

(51) Int. Cl. A01N 47/10; C09D 167/02; C09D 175/04; C08G 63/685; C08G 18/73; C08G 18/38

(52) U.S. Cl. CPC A01N 47/10; C08G 18/73; C08G 18/3831; C08G 18/3825; C09D 175/04; C08G 63/6856; C09D 167/02

(57) ABSTRACT

Methods for killing a microbial are provided that include introducing a functionalized amide polymer to a microbe, where the functionalized amide polymer includes a polymer backbone selected from polyesters and polyurethanes; an amide group with a pendant functional group, where the nitrogen atom of the amide group is part of the polymer backbone; and a net positive charge.

### CROSS-REFERENCE TO RELATED APPLICATIONS

This application claims priority from U.S. provisional patent application Ser. No. 62/269,150 filed on Dec. 18, 2015 which is incorporated herein by reference in its entirety.

### STATEMENT REGARDING FEDERALLY SPONSORED RESEARCH OR DEVELOPMENT

This invention was made with government support under award number DMR-1352485 awarded by National Science Foundation. The government has certain rights in the invention.

### FIELD OF THE INVENTION

One or more embodiments provides functionalized amide polymers with antimicrobial activity.

### BACKGROUND OF THE INVENTION

The Centers for Disease Control estimates that within the United States there are annually two million people infected with drug resistant strains of bacteria and about 23,000 of those people will die as a direct result of infection. Yet, this mortality rate is significantly higher when the deaths which can be attributed to these bacteria in combination with other preexisting conditions are considered. Furthermore, these numbers are expected to rise dramatically in the near future because of the increasing prevalence of various resistant forms of bacteria, such as methicillin-resistant Staphylococcus aureus and carbapenem-resistant Enterobacteriaceae. Recently, it has been reported that a colistin-resistant strain of Escherichia coli capable of passing resistance via horizontal gene transfer has emerged in China. This is extremely troubling because colistin is only used as a last resort in cases where all other antibiotics have failed. This urgent need for new antimicrobials is further compounded by the fact that there are very few new classes of antimicrobials currently within the development pipeline and there are multiple pressing medical needs that are still unaddressed by these antimicrobials which are within the development pipeline.

Antibiotic resistance in hospitals is a particular area of concern. Hospital acquired (nosocomial) infections are an emergent healthcare issue where routine hospital procedures can expose patients to antibiotic resistant infections. Annually there are about 1.7 million nosocomial infections in the US, of which about 100,000 are fatal, with medical costs in the range of $30 billion annually. These problems are further compounded by an alarming rise in antibiotic resistant microorganisms coupled with a decrease in the number of new antibiotics being approved. Polymeric antimicrobial coatings play a critical role in the prevention of microbial contamination in healthcare, food packaging and textile applications. Several types of polymers have been designed to control microbial infections, classified either as carriers of antimicrobial agents, or containing structural components that confer antimicrobial activity. Polymeric coatings that leach antimicrobial agents, such as silver, are widely used in clothing and in medical implants, however their effectiveness decreases over time due to the finite amount of antimicrobial agent.

One promising source for the development of new antimicrobials which has been gaining interest for clinical use are antimicrobial peptides. These peptides are typically ˜10-50 amino acid residues in length, contain an abundance of charged amino acid residues, and are composed of at least 30% hydrophobic amino acid residues. They have been found to be produced by virtually all forms of life as a means to combat invading microbes. The best characterized means of interaction of antimicrobial peptides is through membrane disruption. The abundance of cationic amino acid residues in the antimicrobial peptides allows for their selective interaction with bacterial cell wall components and membranes because of their greater degree of anionic charge than mammalian cell membranes. Also, specific antimicrobial peptides have been implicated in inhibiting cell wall formation, inhibition of DNA replication and protein synthesis, and selectively binding to and inhibiting enzymes essential to proper function of cell signaling pathways. Unfortunately, the widespread use of antimicrobial peptides has been limited due to their high cost of production and susceptibility to rapid proteolytic degradation.

Presently there is a need in the art for synthetic polymers that can mimic the effects of antimicrobial peptides and polymeric coatings that are inherently antimicrobial.

### SUMMARY OF THE INVENTION

One or more embodiments, are directed to a method for killing a microbial comprising: introducing a functionalized amide polymer to a microbe, where the functionalized amide polymer includes a polymer backbone selected from polyesters and polyurethanes; an amide group with a pendant functional group, where the nitrogen atom of the amide group is part of the polymer backbone; and a net positive charge.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A provides a chart of the minimal inhibitory concentrations (MICs) observed for all of the antimicrobial polyurethanes, Pexiganan, and ampicillin values are in terms of μg/mL

FIG. 1B provides provides a chart of the minimal inhibitory concentrations (MICs) observed for all of the antimicrobial polyurethanes, Pexiganan, and ampicillin values are in terms of mM.

FIG. 2 provides a chart of the kinetics of antimicrobial action against E. coli by select antimicrobial polyurethanes, ampicillin, and Pexiganan in ½ Mueller Hinton Broth. All antimicrobial polyurethanes and Pexiganan were tested at 2×MIC and ampicillin was tested at 100 μg/mL. Each value is the result of three replicates. All error bars indicate +/− one standard deviation.

FIG. 3 provides a chart of the kinetics of antimicrobial action against E. coli by select antimicrobial polyurethanes, ampicillin, and Pexiganan in M9 minimal medium. All antimicrobial polyurethanes and Pexiganan were tested at 2×MIC and ampicillin was tested at 100 μg/mL. Each value is the result of 3 replicates. All error bars indicate +/− one standard deviation.

FIG. 4 provides a chart of the hemocompatibility of the antimicrobial polyurethanes, Pexiganan, and ampicillin over a broad range of concentrations (5-2500 μg/mL). Error bars indicate +/− one standard deviation of a single experiment performed using four replicates.

FIG. 5A provides a chart of NIH 3T3 mouse fibroblast cell viability after 1 hour of exposure to an antimicrobial polyurethane or Pexiganan. Error bars indicate +/− one standard deviation of a single experiment performed using four replicates.

FIG. 5B provides a chart of NIH 3T3 mouse fibroblast cell viability after 24 hours of exposure to an antimicrobial polyurethane or Pexiganan. Error bars indicate +/− one standard deviation of a single experiment performed using four replicates.

FIG. 6A provides a fluorescence microscopy images (10× magnification) of P. aeruginosa biofilms on Glass. Green indicates viable bacteria, red indicates dead bacteria.

FIG. 6B provides a fluorescence microscopy images (10× magnification) of P. aeruginosa biofilms on C—CO₂—P. Green indicates viable bacteria, red indicates dead bacteria.

FIG. 6C provides a fluorescence microscopy images (10× magnification) of P. aeruginosa biofilms on C—CO₂⁻. Green indicates viable bacteria, red indicates dead bacteria.

FIG. 6D provides a fluorescence microscopy images (10× magnification) of P. aeruginosa biofilms on C—NH₂—P. Green indicates viable bacteria, red indicates dead bacteria.

FIG. 6E provides a fluorescence microscopy images (10× magnification) of P. aeruginosa biofilms on C—NH₃⁺. Green indicates viable bacteria, red indicates dead bacteria.

FIG. 6F provides a fluorescence microscopy images (10× magnification) of P. aeruginosa biofilms on C—NH₃⁺ (crosslinked). Green indicates viable bacteria, red indicates dead bacteria.

FIG. 7 provides a graph of Percentage Area Covered by P. aeruginosa over different surfaces.

FIG. 8 provides a Lraph of the bactericidal activity of polymer coatings toward P. aeruginosa.

FIG. 9 provides graph of the hemolysis activity of polymer coatings toward defibrinated sheep blood.

FIG. 10A provides fluorescence microscopy images (10× magnification) of NIH-3T3 mouse embryonic fibroblast cells after 24 h on TCPS (A), C—CO₂—P (B), C—CO₂⁻ (C), C—NH₂—P (D), C—NH₃⁺ (E) and C—NH₃⁺ (crosslinked) (F) surfaces. after LIVE/DEAD staining. Green indicates viable cells, red indicates dead cells.

FIG. 10B provides fluorescence microscopy images (10× magnification) of NIH-3T3 mouse embryonic fibroblast cells after 72 h on TCPS (A′), C—CO₂—P (B′), C—CO₂⁻ (C′), C—NH₂—P (D′), C—NH₃⁺ (E′) and C—NH₃⁺ (crosslinked) (F′) surfaces after LIVE/DEAD staining. Green indicates viable cells, red indicates dead cells.

### DETAILED DESCRIPTION OF ILLUSTRATIVE EMBODIMENTS

In one or more embodiments, an antimicrobial functionalized amide polymer is provided. An antimicrobial functionalized amide polymer may comprise a polymer backbone selected from polyesters and polyurethanes; and an amide group with a pendant functional group, where the nitrogen atom of the amide group is part of the polymer backbone. In one or more embodiments, the functionalized amide polymer may have a net positive charge. The antimicrobial functionalized amide polymer shows advantageous antimicrobial properties toward bacteria.

In one or more embodiments, the antimicrobial functionalized amide may have bactericidal properties. In other embodiments, the antimicrobial functionalized amide may have bacteriostatic properties. The antimicrobial functionalized amide polymer may exhibit antimicrobial towards gram negative and gram positive bacteria.

As previously mentioned, a functionalized amide polymer includes a nitrogen atom of the amide group that is part of the polymer backbone, such that polymers herein can be generally conceptualized by the structure below:

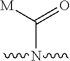

where [symbol] generally represents a polymer backbone selected from polyesters and polyurethanes; and M is a functional group. Suitable functionalized amide polymers and there preparation are described in U.S. Pat. Publ. No. 2015/0094422, U.S. Pat. Publ. No. 2016/0024251, and WO2016049029, all of which is incorporated herein by reference.

In one or more embodiments, the pendant functional groups of the functionalized amide polymers and end-functionalized amide compound having a pendant functional group, which are described below may be an organic group. In some embodiments, the pendant functional group is a group capable of reacting with other reagents to provide a desired functionality in a post-polymerization functionalization step that will be described herein. In other embodiments, the pendant functional group includes a protecting group that protects the M group from reacting with other reagents during monomer creation or polymer creation or both or during post functionalization steps, particularly with multifunctional polymers as described herein. Suitb

[symbol]

In one or more embodiments, a functionalized amide polymer may be prepared by polymerizing an end-functionalized amide compound having a pendant functional group. In one or more embodiments, the end functionalized amide compound having a pendant functional group may be defined by the formula:

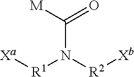

where X^{a} and X^{b} may be the same or different and are each selected from a hydroxyl group and a carboxylic acid group; R¹ and R² may be the same or different and are each hydrocarbon groups; and M is a pendant functional group. In certain embodiments, M may be a cation containing functional group. In one or more embodiments, where one of X^{a} and X^{b} is a hydroxyl group while the other of X^{a} and X^{b} is a carboxylic acid group, the end-functionalized amide compound may be referred to as a hydroxy acid amide compound having a pendant functional group. In one or more embodiments, where both of X^{a} and X^{b} are hydroxyl groups end-functionalized amide compound may be referred to as a diol amide compound having a pendant functional group. In one or more embodiments, where both of X^{a} and X^{b} are carboxylic acid groups, the end-functionalized amide compound may be referred to as a dicarboxylic acid amide compound having a pendant functional group.

In one or more embodiments, suitable hydrocarbon groups for use in the R¹ and R² of the end-functionalized amide compound having a pendant functional group and resultant polymers may be linear, cyclic, or branched hydrocarbon groups. In one or more embodiments, the hydrocarbon groups may include 1 to 10 carbon atoms, in other embodiments 2 to 8 carbon atoms, and in other embodiments, 3 to 6 carbon atoms.

In one or more embodiments, the functionalized amide polymer may be prepared from an amide functional diol compounds and optionally at least one co-monomer. Suitable co-monomers include diisocyanates, dicarboxylic acids, hydroxy acids, and diols.

Suitable dicarboxylic acids useful as copolymers may be defined by the formula:

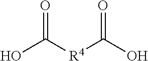

where R⁴ is an organic group.

Advantageously, the organic group R⁴ may be selected to tailor the properties of the thermoresponsive polyester. In one or more embodiments, the hydrophobicity of the polymer may be adjusted by varying the organic group R⁴. For example, the hydrophobicity may be adjusted by altering the chain length of R⁴ or adding a functional group. In one or more embodiments, R⁴ may be a hydrocarbon group with 1 to 10 carbon atoms. In other embodiments, R⁴ may be a polyoxyethylene (O—CH₂—CH₂)ₙ group. Suitable molecular weights of polyoxyethylene groups may be from 200 to 4000, in other embodiments 200 to 2000, and in still other embodiments 200 to 1000. In other embodiments, R⁴ may include a functional group. In these embodiments, the dicarboxylic acids may be referred to as a functional dicarboxylic acids. In certain embodiments, were R⁴ includes a functional group the functional group may be pendantly attached to the dicarboxylic acid. Functional groups may be added to alter the hydrophobicity or add a selectivity to the resultant thermoresponsive polyester. Specific examples of dicarboxylic acids with functional groups include glutamic acid, malic acid, tartaric acid etc., where the amine or hydroxyl group is protected prior to polymerization. Those skilled in the art will appreciate that these functional groups of the functional dicarboxylic acids may be protected. Suitable protecting groups include, but are not limited to Tetrahydropyranyl (THP), tert-butyldimethylsilyl (TBDMS), trimethylsilyl (TMS), and tert-Butoxy carbamate (Boc).

Suitable diisocyanates useful as copolymers may be defined by the formula:

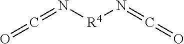

where R⁴ is an organic group.

Similarly with the dicarboxylic acids, the organic group R⁴ of the diisocyanate may be selected to tailor the properties of the thermoresponsive polyester such as hydrophocity and selectivity. In one or more embodiments, R⁴ may be a hydrocarbon group with 1 to 10 carbon atoms. In other embodiments, R⁴ may be a polyoxyethylene (O—CH₂—CH₂)ₙ group. Suitable molecular weights of polyoxyethylene groups may be from 200 to 4000, in other embodiments 200 to 2000, and in still other embodiments 200 to 1000. In other embodiments, R⁴ may include a functional group. In these embodiments, the diisocyanate may be referred to as a functional diol. In certain embodiments, were R⁴ includes a functional group the functional group may be pendantly attached to the diisocyanate.

Suitable diols useful as copolymers may be defined by the formula:

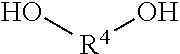

where R⁴ is an organic group.

Similarly with the dicarboxylic acids, the organic group R⁴ of the diol may be selected to tailor the properties of the thermoresponsive polyester such as hydrophocity and selectivity. In one or more embodiments, R⁴ may be a hydrocarbon group with 1 to 10 carbon atoms. In other embodiments, R⁴ may be a polyoxyethylene (O—CH₂—CH₂)ₙ group. Suitable molecular weights of polyoxyethylene groups may be from 200 to 4000, in other embodiments 200 to 2000, and in still other embodiments 200 to 1000. In other embodiments, R⁴ may include a functional group. In these embodiments, the diol may be referred to as a functional diol. In certain embodiments, were R⁴ includes a functional group the functional group may be pendantly attached to the diol.

In certain embodiments, the comonomer may include a crosslinkable group. In one or more embodiments, the crosslinkable group may be a photoresponsive. Exemplary monomers that include photoresponsive crosslinkable groups include photoactive coumarin monomers, examples of which may be found in WO2014074845, encorporated herein by reference. In one or more embodiments, a comonomer with a crosslinkable coumarin group may be defined by the formula

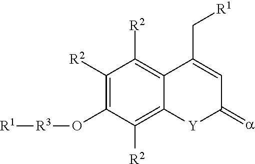

where each R¹ is individually an alcohol, a carboxylic acid, or an isocyanate, each R² is individually a hydrogen atom, a bromine atom, an iodine atom, or a methoxy group; R³ is a hydrocarbon group; Y is an oxygen atom or a nitrogen atom with an organic substitution; and α is an oxygen atom or a sulfur atom.

In one or more embodiments, where the functionalized amide polymer is prepared with a hydroxy acid amide compound having a pendant functional group, the functionalized amide polymer may include a unit defined by formula:

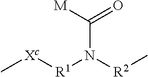

where each X^{c} is an ester group; R¹ and R² may be the same or different and are each hydrocarbon groups; and M is a pendant functional group. In certain embodiments, M may be a cation containing functional group.

In one or more embodiments, where the functionalized amide polymer is prepared with a dicarboxylic acid amide compound having a pendant functional group or a diol amide compound having a pendant functional group, the functionalized amide polymer may include a unit defined by formula defined by formula:

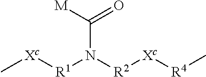

where each X^{c} is a urethane group or an ester group; R¹ and R² may be the same or different and are each hydrocarbon groups; R⁴ is a hydrocarbon group, and M is a pendant functional group. In certain embodiments, M may be a cation containing functional group.

The functionalized amide polymer may include multiple functionalized amide units. In one or more embodiments, the functionalized amide polymer may include two or more different amide units. In these or other embodiments, the two or more different amide units may be in random or block configurations. In one or more embodiments, the two or more pendant functional groups may be a result of polymerizing two or more end-functionalized amide compounds having different pendant functional groups. In other embodiments, the two or more pendant functional groups may be a result post-polymerization modification of the pendant functional groups. In one or more embodiments, the functionalized amide polymer may include and amide unit that provides a positive charge (i.e cation containing pendant functional group) and another amide unit with a hydrophobic pendant functional group.

In one or more embodiments, the functionalized amide polymer may include multiple amide groups with different pendant functional groups. In one or more embodiments, the functionalized amide polymer may include an amide group with cation containing pendant functional group. In these or other embodiments, the functionalized amide polymer may be characterized by the total amount of amide groups with cationic charge containing pendant functional groups. In one or more embodiments, the percent cation containing pendant functional groups of the total amount of pendant functional groups that are attached to amide groups is from about 20% to about 100%, in other embodiments from about 25% to about 75%, and in other embodiments from about 30% to about 50%.

In one or more embodiments, the functionalized amide polymer may include an amide group with a hydrophobic pendant functional group. In these or other embodiments, the functionalized amide polymer may be characterized by the total amount of amide groups with hydrophobic pendant functional groups. In one or more embodiments, the percent hydrophobic pendant functional groups of the total amount of pendant functional groups that are attached to amide groups is from about 0% to about 80%, in other embodiments from about 1% to about 60%, and in other embodiments from about 5% to about 40%.

In one or more embodiments, where the functionalized amide polymer is prepared using end-functionalized amide compounds having a pendant functional group and a co-monomer the functionalized amide polymer may be defined by the formula:

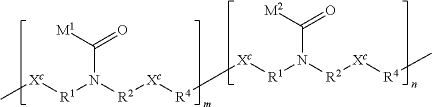

where every X^{c} is a urethane group or every X^{c} is an ester group; R¹ and R² may be the same or different and are each hydrocarbon groups; R⁴ is a hydrocarbon group; m is from about 4 to about 450 units, n is from about 1 to about 350 units, M¹ is a cationic charge containing pendant functional group, and M²is a pendant functional group. In certain embodiments, m may be from about 4 to about 50. In these or other embodiments, n may be from about 1 to about 40. In other embodiments, m may be from about 50 to about 450. In these or other embodiments, n may be from about 40 to about 350.

In particular embodiments, where the functionalized amide polymer is prepared using diol functionalized amide compounds having a pendant functional group and a dicarboxylic acid the functional amide polymer may be a multifunctional polyester defined as below:

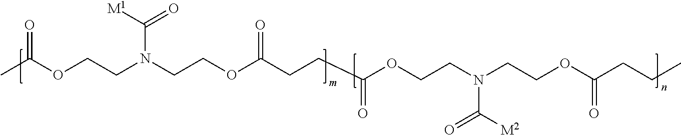

wherein m is from about 4 to about 450 units, n is from about 1 to about 350 units, M¹ is a cationic charge containing pendant functional group, and M² is a pendant functional group. In certain embodiments, m may be from about 4 to about 50. In these or other embodiments, n may be from about 1 to about 40. In other embodiments, m may be from about 50 to about 450. In these or other embodiments, n may be from about 40 to about 350. In certain embodiments, where the functionalized amide polymer is prepared with diol functionalized amide compound having a pendant functional group and a diisocyanate the functional amide polymer may be a multifunctional polyester defined as below:

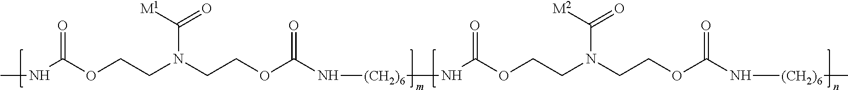

wherein m is from about 4 to about 450 units, n is from about 1 to about 350 units, M¹ is a cationic charge containing pendant functional group, and M²is a pendant functional group. In certain embodiments, m may be from about 4 to about 70. In these or other embodiments, n may be from about 1 to about 60. In other embodiments, m may be from about 50 to about 450. In these or other embodiments, n may be from about 40 to about 350. In one or more embodiments, where the functionalized amide polymer is prepared using a hydroxy acid amide compounds having a pendant functional group, the functionalized amide polymer may be defined by formula (V):

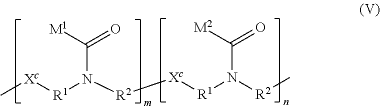

where every X^{c} is an ester group; R¹ and R² may be the same or different and are each hydrocarbon groups; m is from about 4 to about 450 units, n is from about 1 to about 350 units, M¹ is a cation containing pendant functional group, and M² is a pendant functional group. In certain embodiments, m may be from about 4 to about 70. In these or other embodiments, n may be from about 1 to about 60. In other embodiments, m may be from about 50 to about 450. In these or other embodiments, n may be from about 40 to about 350.

In certain embodiments, where the functionalized amide polymer is prepared using a hydroxy acid amide compounds having a pendant functional group, the functionalized amide polymer may be defined as below:

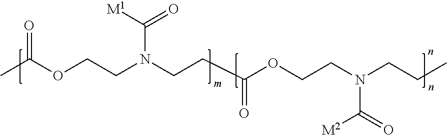

wherein m is from about 4 to about 450 units, n is from about 1 to about 350 units, M¹ is a cation containing pendant functional group, and M² is a pendant functional group. In certain embodiments, m may be from about 4 to about 50. In these or other embodiments, n may be from about 1 to about 40. In other embodiments, m may be from about 50 to about 450. In these or other embodiments, n may be from about 40 to about 350. While depicted above as a polymer with one or two different amide units, the functionalized amide polymer may in other embodiments have more than two amide units. In one or more embodiments, the functionalized amide polymer may have 3, 4, 5, 6, 7, 8, 9, 10, or more different amide units.

The pendant functional groups may be used to impart various functionalities onto the polymer. Suitable functionalities for the pendant groups include, but are not limited to, cationic charge containing groups, hydrophobic groups, groups with moieties that may participate in hydrogen bonding, crosslinking groups, groups that are responsive to various stimuli such as pH, temperature, light and electricity.

Suitable pendant functional groups with a hydrophobic character include

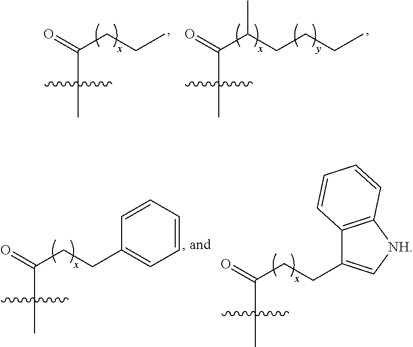

where x is from about 1 to about 22 and y is from about 1 to about 22. Other suitable pendant functional groups with a hydrophobic character include long chain alkyls such as those with about 4 to about 22 carbons and fatty acid chains.

Suitable cation containing pendant functional groups include

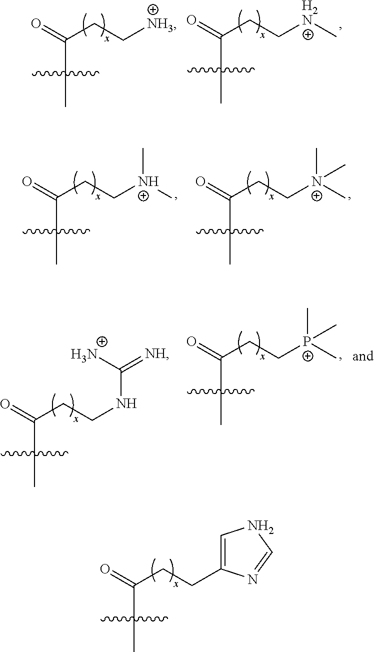

where x is from about 1 to about 22. Exemplary suitable counter ions include, but are not limited to, Cl—, Br—, I—, TFA-(trifluoroacetate); and PF6-(hexafluorophosphate).

Suitable pendant functional moieties that may participate in hydrogen bonding include

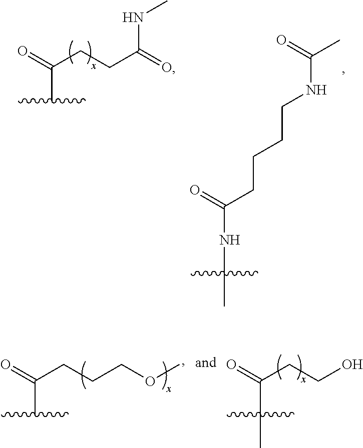

where x is from about 1 to about 22.

The molecular weight of the functionalized amide polymer may be determined through size exclusion chromatography. In certain applications, the functionalized amide polymers are made to have a number average molecular weight from about 3,000 g/mol to about 45,000 g/mol, in other embodiments from about 5,000 to about 30,000 g/mol, and in other embodiments from about 10,000 g/mol to about 20,000 g/mol. In other applications, the functionalized amide polymers are made to have a number average molecular weight from about 25,000 g/mol to about 200,000 g/mol, in other embodiments from about 30,000 g/mol to about 150,000 g/mol, and in other embodiments from about 50,000 g/mol to about 100,000 g/mol. In one or more embodiments, the polydispersity of the functionalized amide polymer polyesters may range from about 1.1 to about 2.5.

In one or more embodiments, the functionalized amide polymer may be use as a surface coating. Advantageously, the functionalized amide polymer may be used as a surface coating for medical devices such as surgical tools, catheters or surfaces in the hospital to provide antimicrobial activity to devices and surfaces. In one or more embodiments, such as coating of medical devices or surface, the functionalized amide polymer may be a substantial portion of the coating composition. In other embodiments, such as inclusion in a paint the functionalized amide polymer may be used as an additive or adjuvant in a coating composition.

In one or more embodiments, the functionalized amide polymer may be water soluble. As those skilled in the art will appreciate the solubility of the functionalized amide polymer may be affected by certain paramertes such as the molecular weight, hydrophobicity of the comonomer, amount, and the ratio and amount of hydrophobic and ionic functional groups. Those skilled in the art will be able to select and prepare water soluble functionalized amide polymers by selecting and adjusting the polymer constituents. Conversely, in other embodiments, the functionalized amide polymer may be insoluble in water.

In one or more embodiments, the functionalized amide polymer may be included in a pharmaceutical composition. Pharmaceutical compositions may include a functionalized amide polymer derivative, or a pharmaceutically acceptable salt thereof and at least one pharmaceutically acceptable excipient. The pharmaceutical compositions include those suitable for dermal, subdermal, inhalation, oral, topical or parenteral use. , a Examples of pharmaceutical compositions include, but are not limited to, tablets, capsules, powders, granules, lozenges, or liquid preparations. In or more embodiments, a water insoluble amide functionalized polymer, may be prepared into a nanoparticle. Water insoluble amide functionalized polymer nanoparticles may be suitable as antimicrobials for inhalation or subcutaneous, dermal or intravenous delivery.

Tablets and capsules for oral administration may be in unit dose presentation form, and may contain conventional excipients such as binding agents, for example syrup, acacia, gelatin, sorbitol, tragacanth, or polyvinylpyrollidone; fillers, for example lactose, sugar, maize-starch, calcium phosphate, sorbitol or glycine; tableting lubricants, for example magnesium stearate, talc, polyethylene glycol or silica; disintegrants, for example potato starch; or acceptable wetting agents such as sodium lauryl sulphate. The tablets may be coated according to methods well known in normal pharmaceutical practice.

Liquid preparations may contain conventional additives, such as suspending agents, for example sorbitol, methyl cellulose, glucose syrup, gelatin, hydroxyethyl cellulose, carboxymethyl cellulose, aluminium stearate gel or hydrogenated edible fats, emulsifying agents, for example lecithin, sorbitan monooleate, or acacia; non-aqueous vehicles (which may include edible oils), for example almond oil, oily esters such as glycerin, propylene glycol, or ethyl alcohol; preservatives, for example methyl or propyl p-hydroxybenzoate or sorbic acid, and, if desired, conventional flavoring or coloring agents.

For parenteral administration, fluid unit dosage forms are prepared utilizing the compound and a sterile vehicle, water being preferred. The compound, depending on the vehicle and concentration used, can be either suspended or dissolved in the vehicle or other suitable solvent. In preparing solutions, the compound can be dissolved in water for injection and filter sterilized before filling into a suitable vial or ampoule and sealing. Advantageously, agents such as local anesthetics, preservatives and buffering agents etc. can be dissolved in the vehicle. To enhance the stability, the composition can be frozen after filling into the vial and the water removed under vacuum. The dry lyophilized powder is then sealed in the vial and an accompanying vial of water for injection may be supplied to reconstitute the liquid prior to use. Parenteral suspensions are prepared in substantially the same manner except that the compound is suspended in the vehicle instead of being dissolved and sterilization cannot be accomplished by filtration. The compound can be sterilized by exposure to ethylene oxide before suspending in the sterile vehicle. Advantageously, a surfactant or wetting agent is included in the composition to facilitate uniform distribution of the compound.

Pharmaceutical compositions may contain from 0.1% to 99% by weight functionalized amide polymer, or pharmaceutically acceptable salt thereof depending on the method of administration.

While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

### Peptidomimetic Polyurethanes

The synthesis of polyurethanes was carried out using four different mLys and mVal compositions with hexamethylene diisocyante (HDI). The four selected compositions of diols were 50/0, 45/5, 35/15, and 25/25 mLys/mVal. These compositions were chosen to synthesize a range of polyurethanes that varied in the balance of cationic and hydrophobic character yet were still water soluble. HDI was selected because it is widely available and it is considered more compatible for biological use than aromatic diisocyantes. Polymerizations were mediated by use of either dibutyl tin dilaurate (DBTDL) or tin(II) 2-ethylhexanoate (TEH). Using these two catalysts, two molar mass ranges were obtained; DBTBL resulted in polyurethanes in the number average molar mass range of ˜22-31 kDa (high molar mass, HM) while TEH resulted in polyurethanes in the range of ˜9-13 kDa (low molar mass, LM) under the same reaction conditions. Perhaps, these different molecular mass ranges can be explained by the fact that difunctionalized tin (IV) catalysts are typically more active catalysts. All polyurethanes were characterized by ¹H NMR. All polyurethanes that were synthesized are summarized in Table 1. After the polyurethanes were synthesized, the amines were deprotected using 1:2 4N HCl in dioxane: methylene chloride and provided cationic polyurethanes with mLys and mVal pendant groups.

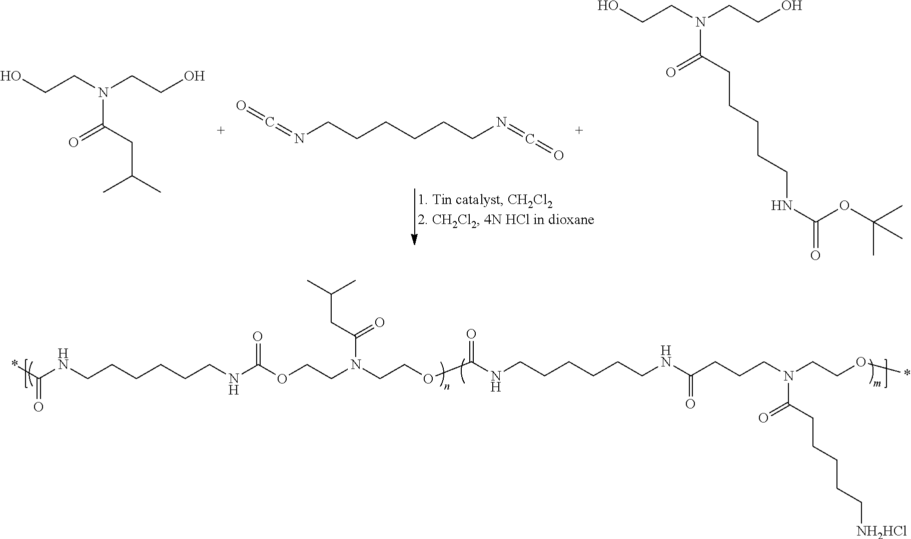

Scheme 1: Polymerization of water soluble ‘peptidomimetic’ polyurethanes.

In order to evaluate the ability of these polyurethanes to perform as antimicrobials, antimicrobial susceptibility assays were performed to determine the minimum inhibitory concentration (MIC). These assays were performed using two types of bacteria; E. coli and S. aureus. Both E. coli and S. aureus were investigated using ½ Mueller Hinton Broth (½ MHB), a complex, protein rich medium that is recommended for antimicrobial susceptibility assays by the CLSI. In our experiments, a one half formulation of the medium was used because the polymers were insoluble in the broth at high concentrations and it allowed for preparation of various concentrations of polyurethane solutions which contained consistently the same amount of salts and protein, both of which have been shown to have a significant impact on the antimicrobial activity of peptides and synthetic polymers. E. coli was additionally tested in M9 Minimal Medium (M9MM), a defined medium that contains just essential salts and dextrose, to determine whether antimicrobial activity can be enhanced in simpler media.

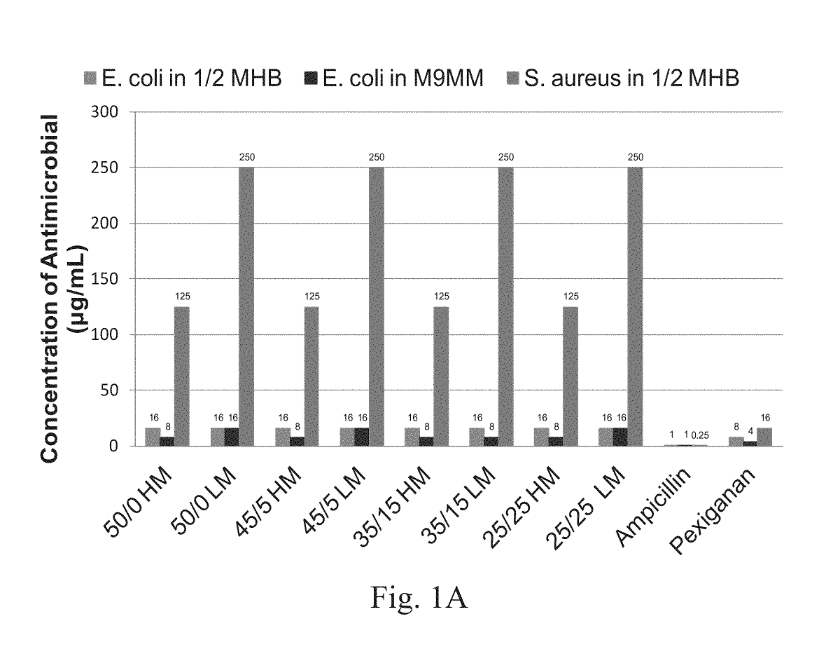

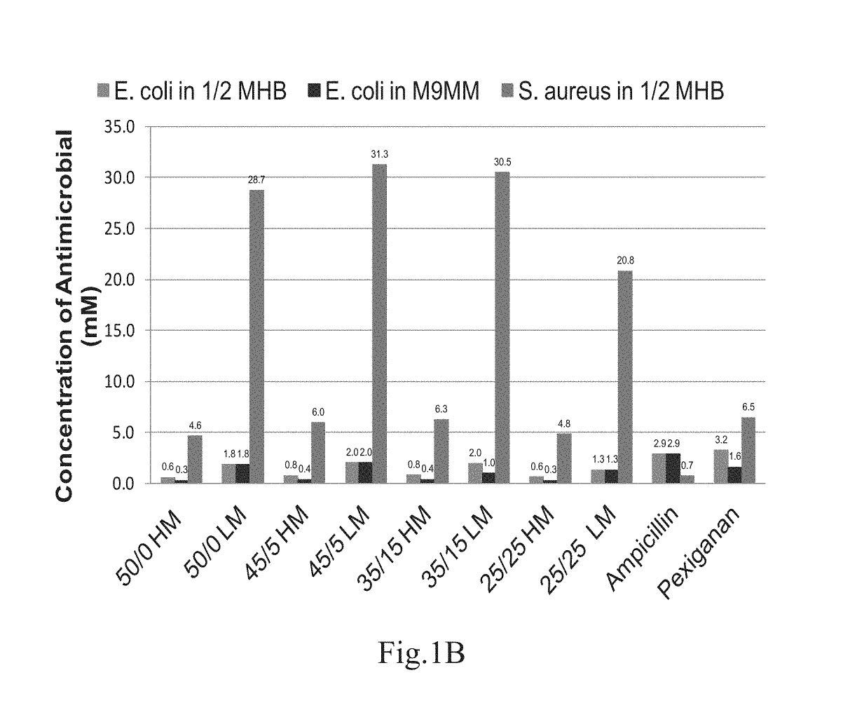

The MICs for all polyurethanes, as well as ampicillin, a traditional β-lactam antibiotic, and Pexiganan, a well-studied antimicrobial peptide, were determined (FIGS. 1A and 1B). The most striking observation from these results is the large difference in MIC values for E. coli and S. aureus (FIG. 1A), with the polymers being effective against E. coli at very low concentrations 8-16 μg/mL, which are in the same range shown for Pexiganan. Contrary to this, the polymers were not very effective against S. aureus with MICs of 125-250 μg/mL. To the best of our knowledge, such large selectivity between gram negative and gram positive bacteria have not been reported with synthetic antimicrobial polymers. Further analysis of the results shows that the composition of the polyurethanes does not influence the MIC.

This is most apparent for the polyurethanes tested in ½ MHB with all of them exhibiting an MIC of 16 μg/mL for E. coli. This was unexpected as literature precedent with synthetic polymeric antimicrobials shows modulation of MIC with the hydrophobic/hydrophilic balance of the polymers. This trend also holds true when observing the antimicrobial activity of the polyurethanes when testing for the MIC of S. aureus in ½ MHB and the MIC of E. coli in M9MM. For S. aureus in ½ MHB, the observed MICs for all HM polyurethanes were determined to be 125 μg/mL and the MICs for the LM polyurethanes under the same conditions were determined to be 250 μg/mL. The observed MICs for E. coli in M9MM were observed to be 8 μg/mL for all of the HM polyurethanes and the 35/15 LM polyurethane and 16 μg/mL for remaining LM polyurethanes.

When the polymers are plotted in terms of molarity (mM) of each antimicrobial as opposed to weight of antimicrobial per volume of medium (μg/mL), the performance of all of the polyurethanes exceeds that of ampicillin and Pexiganan in controlling the growth of E. coli (FIG. 1B). Also, when compared by molarity, the HM polyurethanes perform similarly to Pexiganan in controlling S. aureus growth. These observations are rather interesting because they indicate that each polyurethane chain on average performs more effectively or comparably to each molecule of the well-studied antimicrobials ampicillin and Pexiganan.

To gain a better understanding of the interaction of the antimicrobial polyurethanes with E. coli, we performed time/kill plating assays. These assays were performed to determine the kinetics of action of the antimicrobial polyurethanes and establish whether they have a bactericidal or bacteriostatic effect at concentrations of 2×MIC. For these experiments, the two polyurethane compositions at each extreme, the 50/0 and 25/25 mLys/mVal polyurethanes, were used to probe the role of mVal in the antimicrobial properties of the polyurethanes since it seemed to have a minimal impact on MIC. Along with the antimicrobial polyurethanes, Pexiganan was tested at 2×MIC as well and ampicillin at 100 μg/mL, which is a standard.

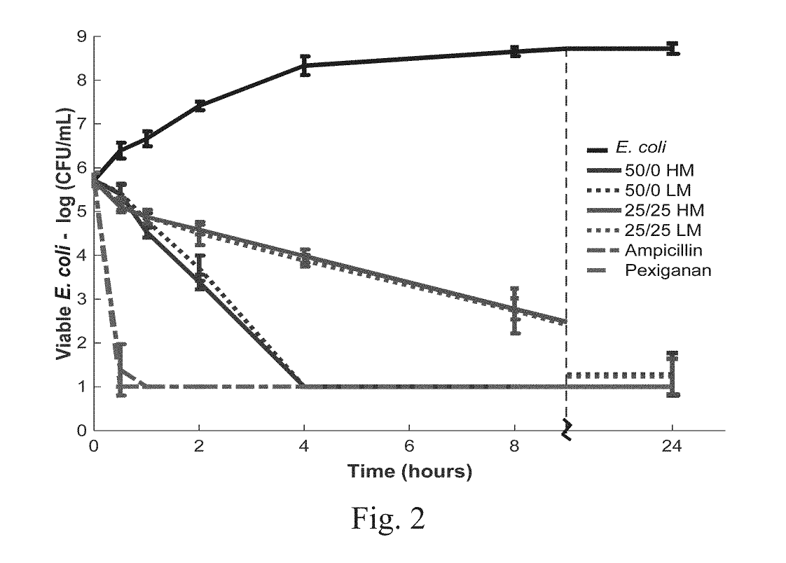

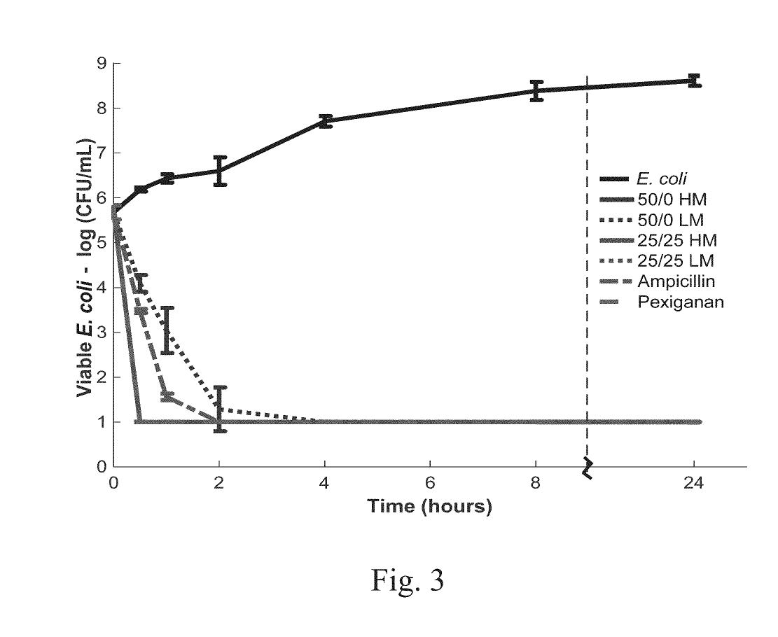

Bacteriogram concentration. The results show that in both ½ MHB and M9MM media the polyurethanes are bactericidal (FIGS. 2 and 3). However, a rather prominent observation is that the rate of killing for all polyurethanes is very different depending on the medium used; faster kinetics were observed in the simpler M9MM than in the ½ MHB. It required about eight hours for the 25/25 polyurethanes to achieve 99.9% killing of the E. coli in ½ MHB while it required less than 30 minutes to achieve the same in M9MM. A similar yet less extreme reduction of the time necessary to kill E. coli was observed using the 50/0 polyurethanes and this difference may be due to the more hydrophobic polyurethanes to bind to the proteins in the medium. Also, it can be observed from the assay performed in ½ MHB that molar mass of the antimicrobial polyurethanes appear to have very little, if any, effect on the kinetics and that the rates of killing are very dependent on the chemical composition of the polymers. This same effect is not observed when the assay is performed in M9MM; the bactericidal kinetics of both the 50/0 polyurethanes are not the same.

In addition to exhibiting good antimicrobial properties, minimal interaction of antimicrobials with mammalian cells is desirable. Previous studies using water soluble cationic polymers have shown that the balance of cationic and hydrophobic character of the polymer is not only important in determining the effectiveness in killing bacteria but also in determining how the polymer interacts with mammalian cells. Various studies have been performed previously using polymers which varied the chain lengths of the pendent groups which attach the cationic moiety to the backbone and, in the case of quaternized ammoniums, the N-alkyl chain lengths. For each type of polymer tested, a desirable balance between cationic and hydrophobic components can be established. Typically, it is observed that polymers which are too hydrophobic or too cationic are either very weakly antimicrobial and/or highly toxic to mammalian cells. Also, molar mass has been shown to play an important role in determining the effect of the polymers on mammalian cells. Typically, it is observed that the greater the molar mass, the more effective the material is in killing all cells, both bacterial and eukaryotic.

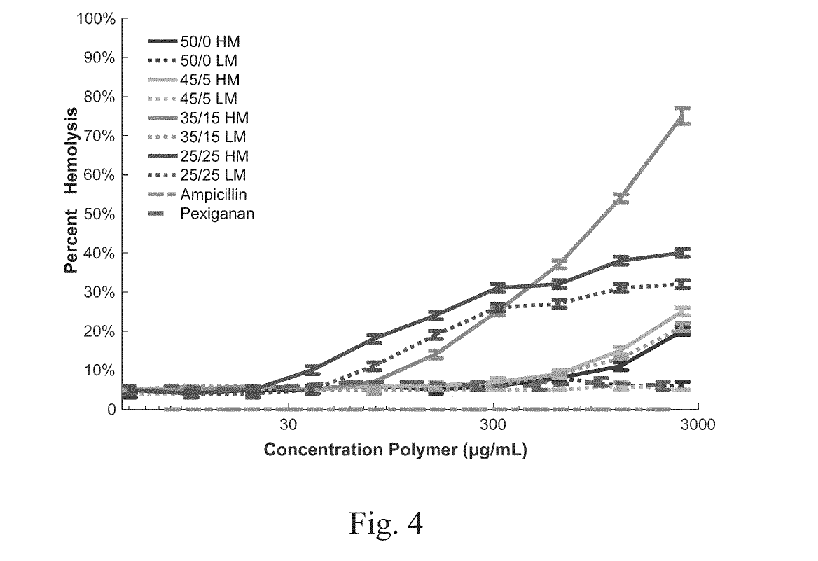

Therefore, in order to establish the compatibility of the antimicrobial polyurethanes with mammalian cells, we began by investigating their hemocompatibility with defibrinated sheep blood (FIG. 4). The results show that exposure of blood cells to the polyurethanes for 1 h at various concentrations showed very low hemolysis at concentrations close to the MIC. At much higher concentrations, hemolysis was observed with hydrophobic polyurethanes with higher molar mass. These trends which emerge from the data are consistent with what is expected for these materials. However, what was not expected was the exceptional tolerance of these materials at such high concentrations, especially for the 50/0 and 45/5 polyurethanes. For the 50/0 and 45/5 HM polyurethanes, less than 10% hemolysis was observed up to about 625 μg/mL. This is rather significant because these two polymers have Mₙ˜30 kDa. Perhaps, this greater tolerance of the HM polyurethanes is due to the more hydrophilic nature of the backbone. Previous studies have shown that the addition of polar, uncharged pendent groups to antimicrobial polymers decreased their hemolytic activity . Also, the 50/0 and 45/5 LM polyurethanes maintained ˜5% hemolysis across the entire range of concentrations tested. This is very impressive because such a low amount of hemolysis is comparable to Pexiganan, which was tested under the same conditions alongside the antimicrobial polyurethanes. The 35/15 and 25/25 polyurethanes showed less desirable results; both HM and LM 25/25 as well as the HM 35/15 polyurethanes all exceeded 10% hemolysis at concentrations around 100 μg/mL. The 35/15 LM polyurethane exhibited significantly less hemolysis than the 35/15 HM polyurethane and exceeded 10% hemolysis at concentrations greater than 625 μg/mL.

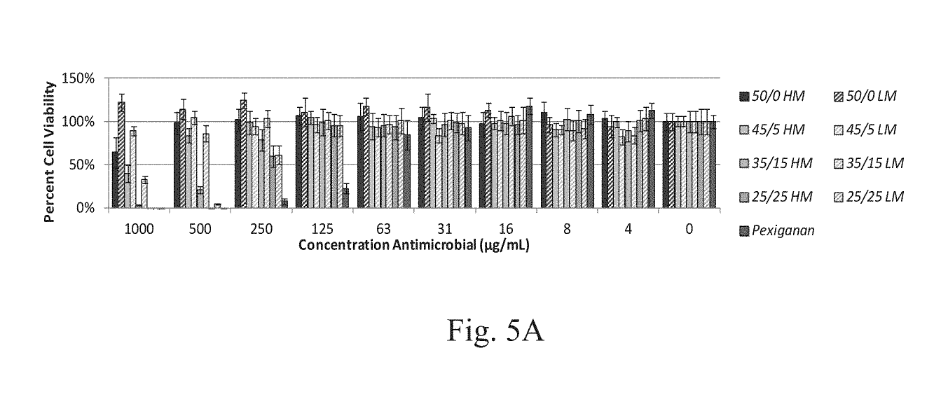

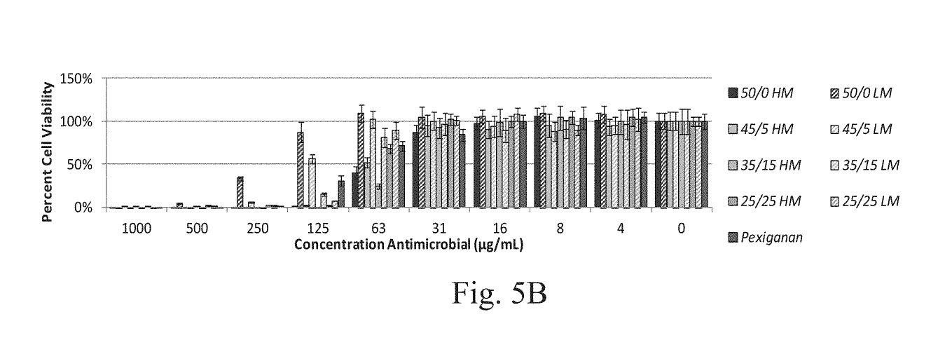

To further investigate mammalian cell compatibilities, cell viability was investigated using NIH 3T3 mouse fibroblast cells. For these experiments, the cells were exposed to the polymers for 1 hour as well as 24 hours to determine the short term and long term effects of the antimicrobial polyurethanes on their viability. The results of the 1 hour assay, shown in FIG. 5A, corroborated multiple trends and observations which were apparent in the hemolysis assay. From the results of the 1 hour cell viability assay, it can be observed that the HM polyurethanes exhibited a significantly greater amount of cytotoxicity than the LM polyurethanes of the same composition. Also, there was a significant difference noticed between polyurethanes of different compositions with the greatest differences being observed between the most hydrophilic compositions, 50/0 and 45/5, and the most hydrophobic compositions, 35/15 and 25/25. It was additionally determined that Pexiganan was not as compatible with the NIH 3T3 cells as it was with the sheep blood. In fact, after 1 hour of exposure, all the antimicrobial polyurethanes were significantly more compatible with the cells than Pexiganan; a significant drop in viability of cells exposed to 125 μg/mL of Pexiganan is observed while the cells exposed to 125 μg/mL of all tested antimicrobial polyurethanes still remained near 100% viable.

FIG. 5B shows the results of the 24 hour cell viability assay and when compared to the 1 h viability results, there appears to be a kinetic aspect to the interaction of the cells with the antimicrobial polyurethanes. Higher concentrations of antimicrobial polyurethane which were compatible with the cells after 1 hour of exposure were not compatible after 24 hours of exposure to the antimicrobial polyurethanes. This observation is most apparent when observing the HM polyurethanes. After one hour of exposure, the HM polyurethanes exhibited a range of compatibilities dependent upon the ratio of mLys to mVal. However, after 24 hours of exposure to the antimicrobial polyurethanes, the previously observed range has completely diminished and all HM polyurethanes showed a significant decrease in cell viability at the tested concentrations of 63 μg/mL and above. Although the range of compatibility for the LM polyurethanes decreased after 24 hours of exposure, there still remained a considerable difference in viability between the different compositions of mLys and mVal monomer. Even though there was a significant decrease in viability after 24 hours, the 50/0 LM polyurethane had a minimal impact on cell viability up to about 125 μg/mL. Also, it must be noted that when comparing the viability of cells exposed to Pexiganan for 1 hour and 24 hours, there is not as significant of a decrease in cell viability as there was with the antimicrobial polyurethanes.

A useful means to further analyze the effectiveness of each antimicrobial is through the generation of a dimension-less selectivity index which reflects the selectivity of the antimicrobial to affect bacteria over mammalian cells. These values were generated from the hemolysis and cell viability data by identifying the tested concentration for each antimicrobial polyurethane and Pexiganan which induced either 10% hemolysis of sheep blood (HC₁₀) or induced cytotoxicity which resulted in a decrease in cell viability below 90% (IC₉₀) and dividing the values by the obtained MICs (Table 2). The greater the selectivity index, the more selective the antimicrobial is towards bacteria. As shown in Table 2, the hydrophilic 50/0 and 45/5 polyurethanes matched the performance or performed significantly better than Pexiganan in targeting E. coli. When compared in terms of HC₁₀, the actual values of Pexiganan and the 50/0 and 45/5 LM polyurethanes were unable to be accurately obtained because all three did not exceed 10% hemolysis; even at a concentration of 2.5 mg/mL. Moreover, the selectivity indices of the 50/0 LM polyurethane obtained from IC₉₀ values after 1 and 24 hours are both greater than that of Pexiganan. However the antimicrobial polyurethanes are incapable of selectively targeting S. aureus over the tested mammalian cells. Also, it is seen that the 35/15 and 25/25 polyurethanes performed rather marginally in selectively targeting E. coli over mammalian cells.

Overall, the results of these experiments indicate very good antimicrobial activity of the polyurethanes, especially the LM 50/0 and 45/5 polyurethanes. To the best of our knowledge, the selectivity of these polyurethanes for the gram negative E. coli and lack of selectivity for gram positive S. aureus is unprecedented. Published results show that other water soluble synthetic polymers have shown nearly equal capabilities to affect both E. coli and S. aureus or have a slightly greater effect on S. aureus. Various studies have been performed to determine the mechanism of action of antimicrobial polymers on bacteria. From studies with model bacterial membranes, it has been shown that the greater negative charge inherently present on the membrane of bacteria is the most significant determining factor in selectivity over mammalian cells. Studies by Kuroda et al indicate that their antimicrobial polymers form micellar aggregates and segregate into cationic and hydrophobic rich domains which facilitate membrane disruption. Also, the work of Schmidt and Wong has indicated that for an AMP or polymer to disrupt a membrane, a negative Gaussian curvature must be induced by the assembly of polymer chains on the surface. Perhaps, this greater effectiveness of our antimicrobial polyurethanes on E. coli than on S. aureus is due to interactions beyond those with the cell well. However, many more experiments will be necessary to provide further detail and such experiments will provide an interesting direction for future studies.

### Non-Toxic Cationic Coumarin Polyester Coatings

Materials. All the solvents, tert-Butyldimethylchlorosilane, di-tert-butyl dicarbonate, casamino acid, live/dead BacLight Bacterial Viability Kit and LIVE/DEAD BacLight mammalian Vitality Kit were purchased from Thermo Fisher Scientific (Waltham, Mass.) and were used as received. Acetone was distilled prior to use. Dichloromethane was dried by distilling over anhydrous calcium hydride (CaH₂). Sodium bisulfate (NaHSO₄), potassium carbonate (K₂CO₃), 18-crown-6, p-toluenesulfonic acid (PTSA; CH3C6H4SO3H), 4 Å molecular sieves, 3-bromo-1-propanol, trimethylamine, and succinic acid were purchased from Acros Organics (Morris Plains, N.J.). Ethyl 4-chloroacetoacetate and hydroquinone bis(2-hydroxyethyl) ether was purchased from Alfa Aesar (Haverhill, Mass.), and diisopropylcarbodiimide (DIC) was purchased from Oakwood Chemicals (Estill, S.C.). 4-(Dimethylamino)pyridinium-4-toluenesulfonate (DPTS) was prepared according to literature methods.³² 4N HCl solution in 1,4-dioxane, DABCO, triton X-100, agar, Mueller-Hinton broth, calcium chloride (CaCl₂), Fe-EDTA, ammonium sulfate ((NH₄)SO₄), disodium hydrogen phosphate (Na₂HPO₄), monopotassium phosphate (KH₂PO₄), sodium chloride (NaCl), magnesium chloride (MgCl₂), sodium citrate, Sodium thiosuffate (Na₂S₂O₃) and 6-aminohexanoic acid were purchased from Sigma Aldrich (St. Louis, Mo.). Dimethylaminopyridine, t-butyl alcohol, dimethylaminopyridine, diethanolamine, thionyl chloride, N-Hydroxysuccinimide, iodine and sheep blood were purchased from VWR (Radnor, Pa.). Silica gel (40-63 μm, 230×400 mesh) for column chromatography was purchased from Sorbent Technologies, Inc (Norcross, Ga.).

Characterization. ¹H Nuclear magnetic resonance (NMR) spectra were recorded on a Varian Mercury 300 MHz spectrometer spectrophotometer (Palo Alto, Calif., USA). Chemical shifts are reported in ppm (δ) relative to residual solvent signals. Size exclusion chromatography (SEC) was performed on a TOSOH EcoSec HLC-8320, with two PSS Gram Analytical SEC Columns in series, using 25 mM LiBr in DMF as eluent at a flow rate of 0.8 mL/min. The column and detector temperatures were maintained at 50° C. Molecular weights were obtained relative to PMMA standards using the refractive index (RI) signal. Thermal transitions were analyzed using a differential scanning calorimeter (DSC) TA Q2000 with a liquid N₂ cooling unit using a cooling cycle of 10° C./min and heating rate also at 10° C./min. TA Q500 thermogravimetric analyzer (TGA) was used to collect 5% decomposition temperature data from 25° C. to 600° C. at a heating rate of 10° C./min in a N₂ atmosphere. Coating thickness was measured on an UV-visible-NIR (240-1200 nm) variable angle spectroscopic ellipsometer (VASE M-2000, J.A. Woollam Co.). Atomic force microscopy (AFM) images were obtained on DI MultiMode SPM AFM (Tapping mode). Imaging was done on an IX51 Epifluorescence Microscope (Olympus Co., Japan) using the DAPI, FITC and TRITC filters. Crosslinking of the polymer was done in a Rayonet® RMR-200 reactor at 350 nm wavelength. Contact angles were measured on Ramé-Hart Instruments Advanced Goniometer 500 F1 and analyzed with Drop Image Advanced software.

Synthesis of coumarin diol monomer: Resorcinol (10 g, 91 mmol) was reacted with 4-chloromethyl acetoacetate (17 g, 103 mmol) in the presence of p-toluenesulfonic acid (3.6 g, 19 mmol) in toluene (150 mL) and refluxed at 110° C. for 45 minutes. The reaction mixture was purified by extraction in water and ethyl acetate and dried under vacuum. Further purification was done via silica gel liquid column chromatography (ethyl acetate: hexanel:9) to yield 7-hydroxy-4-(chloromethyl)coumarin (1) (12 g, 65% yield). Then, compound (1) (2.95 g, 14 mmol) was refluxed over a stirring solution of water (350 mL) for 3 days to hydrolyze the chloromethyl into a hydroxymethyl group. The reaction mixture was filtered while hot, and cooled to room temperature over 12 h to yield 7-hydroxy-4-(hydroxymethyl)coumarin (2) (2.7 g). The product was used further without purification. The final 7-(hydroxypropoxy)-4-(hydroxymethyl)coumarin (3) was synthesized by combining (2) (1.0 g, 5.2 mmol) with potassium carbonate (2 g, 14.5 mmol), 18-crown-6 (0.7 g, 2.65 mmol), and 3-bromo-l-propanol (1.5 g, 10.8 mmol) and dissolving in dry acetone (15 mL) and refluxing at 55° C. for 2.45 hours in a CEM Discover microwave reactor. The reaction mixture was filtered and solvent was removed under reduced pressure and purified via silica gel liquid column chromatography using a mixture of ethyl acetate and hexane as the mobile phase. The product was dried under reduced pressure to yield pure (3) (1.18 g, 91%). The coumarin monomers were characterized by ¹HNMR.

Synthesis of t-butyl protected carboxylic acid monomer (6): Succinic anhydride (10 g, 100 mmol) was reacted with anhydrous t-butyl alcohol (17 mL) in anhydrous toluene (150 mL) in the presence of dimethylaminopyridine (1.8 g, 15 mmol), N-hydroxysuccinamide (3.45 g, 30 mmol), and trimethylamine (4.2 mL, 30 mmol) to yield the ring opened mono-tert-butylsuccinate product (4). The product was purified by ethyl acetate and water extractions followed by recrystallization of the isolated products of the organic phase in 1:3 ether:hexanes (77%). The pure compound (4) (5.57 g, 31.9 mmol) was then reacted with tert-Butyldimethylchlorosilane (TBDMS) protected diethanolamine (24.6 mmol) in a 1-ethyl-3-(3-dimethylaminopropyl) carbodiimide (EDC) (6.60 g, 34.4 mmol) mediated coupling reaction in anhydrous N,N-dimethylformamide (DMF) (30 mL) overnight. The resulting product (5) was purified by removing the DMF via rotovap, performing ethyl acetate and water extractions, and further purifying the product by performing silica gel liquid column chromatography using ethyl acetate and hexanes as the mobile phase (69.8%). Deprotection of the TBDMS groups was performed by reacting the purified product from the previous step with iodine in methanol (2% w/v) at reflux for three hours. After reaction, Na₂S₂O₃ was added until the reaction mixture became clear and was concentrated on rotary evaporator. To purify the t-butyl protected carboxylate diol monomer (5), methylene chloride and water extractions were performed followed by silica gel liquid column chromatography using methylene chloride and methanol as the mobile phase to purify the products extracted into the organic phase. The product was dried under reduced pressure to yield pure monomer (6) (61%). Synthesis of the monomer was confirmed by ¹HNMR.

Synthesis of Boc-protected amine monomer (9): 6-Aminohexanoic acid (10 g, 76.2 mmol) was esterified into its corresponding methyl ester by dissolving it in a large excess of anhydrous methanol (125 mL) and adding thionyl chloride (22.9 g, 193 mmol) dropwise. After reacting overnight and removing the excess methanol via rotary evaporator, the methyl-6-aminohexanoate (7) was dissolved in 50 mL of a 50/50 (by volume) mixture of water and dioxane and triethylamine (19.2 g, 190 mmol) was added to make the solution alkaline. Then, di-tert-butyl dicarbonate (20.5 g, 91 mmol) dissolved in 50 mL of 50/50 water and dioxane was added dropwise to the solution of methyl-6-aminohexanoate. The resulting methyl-6-(amino-N-tert-butoxycarbonyl)hexanoate (8) was purified via ethyl acetate and water extractions and dried under vacuum (17.8 g, 95.5%). Compound (8) was reacted with diethanolamine (15.9 g, 151 mmol) neat at 80° C. under vacuum to yield the desired Boc-protected amine diol monomer (9). The monomer was purified via silica gel liquid column chromatography using a mixture of methylene chloride and methanol as the mobile phase. The product was dried under reduced pressure to yield pure monomer (9) (17.5 g, 75.7%). Synthesis of the monomer was confirmed with ¹HNMR.

Synthesis of coumarin polyesters: The coumarin polyesters with protected carboxylic acid (C—CO₂—P) or amine (C—NH₂—P) functional groups were synthesized by the room temperature carbodiimide-mediated polymerization of diol and diacid and shown in Scheme 1. Coumarin diol (3) (0.5 g, 1.99 mmol, 0.75 equiv), pendant t-butyl protected carboxylate diol monomer (6) (0.17 g, 0.06 mmol, 0.25 equiv) or pendant Boc-protected amine diol monomer (9) (0.21 g, 0.06 mmol, 0.25 equiv), and succinic acid (0.31 g, 2.66 mmol, 1 equiv) were taken in an evacuated and N₂ filled round bottomed flask along with 4-(N,N-dimethylamino) pyridinium-4-toluenesulfonate (DPTS) (0.31 g, 1.06 mmol, 0.25 equiv). Dichloromethane (1 mL for every 2 mmol diacid) was then added and stirred until monomer dissolved in the solvent. Then the solution was cooled over ice bath to 0° C. and N,N-diisopropylcarbodiimide (DIC) (1.25 mL, 3 equiv) was added dropwise via syringe. The reaction was allowed to come to room temperature and stirred for 48 h under nitrogen. The polymer was precipitated in methanol twice and dried under vacuum to yield a solid (85%). The polymers were characterized by ¹FINMR, SEC, TGA and DSC.

Deprotection of coumarin polyesters: The protected carboxylic acid (C—CO₂—P) (0.35 g) and/or protected amine (C—NH₂—P) (0.35 g) polyesters were dissolved in 1.5 mL of CH₂Cl₂ in a round bottomed flask equipped with stir bar. This solution was cooled to 0° C. and 0.7 mL of 4N HCl in 1,4-dioxane was added and stirred for 45 minutes at room temperature (Scheme 1). Then, HCl/Dioxane was removed from reaction mixture under reduced pressure and the polymer was dissolved in 2 mL CH₂Cl₂ and precipitated from diethyl ether and dried. Anionic carboxylic acid (C—CO₂⁻) and cationic amine (C—NH₃⁺) polyesters were characterized by ¹HNMR, TGA and DSC.

### Coating Preparation

Spin coating of polymers on glass coverslips: Circular coverslips (12 mm), thickness number 1 were cleaned by sonicating in methanol for 15 minutes and acetone for another 15 minutes. Each coverslip was dried under argon and visually inspected to ensure they were free of any debris or imperfections after solvent washing. Right before spin coating, the coverslips were etched in plasma cleaner for 10 mins. Spin coating was performed by preparing 2% (w/v) solutions of polymers in chloroform. For the cationic amine polyester, spin coating was performed using 2% (w/v) polymer solution in a 9:1 CHCl₃: DMF mixture. The polymer solution was spin coated on the coverslips at 2000 rpm for 60 seconds and dried and annealed at 65° C. in a vacuum oven.

Spin coating of polymers on silicon wafer: Silicon wafers were cleaned with piranha solution (H₂SO₄: H₂O₂₋ 7:3 (v/v)) at 90° C. for 45 minutes, rinsed with water and dried by argon prior to spin coating. Polymer solution was spin coated on silicon wafer in the same manner as with the glass coverslips.

Crosslinking of polymeric coating: Coated coverslip containing cationic amine polyester was placed on a Petri dish and irradiated from top at 350 nm for 10 minutes in a Rayonet® RMR-200 reactor.

Surface roughness and thickness measurement: The spin coated polymer on silicon wafer was used for roughness and thickness measurements. Surface roughness was measured by AFM and surface thickness was measured by ellipsometry.

Contact angle measurement: Circular coverslips (12 mm) were cleaned and spin coated as indicated above. The static contact angle of Milli-Q water was measured on a Ramé-Hart Instruments Advanced Goniometer 500 F1 and analyzed with Drop Image Advanced software. 10 μL of Milli-Q water was deposited on the surface and immediately the contact angles were measured over a period of 120 sec at 25° C. Three measurements were taken for each sample.

Coating stability measurement: The cationic amine polyester coated coverslips (non-crosslinked and crosslinked) were incubated at 37° C. in phosphate-buffered saline (PBS), pH 7.4, for a period of 1 month. The surface of each spin coated sample was analyzed before and after incubation using a IX51 Epifluorescence Microscope (Olympus Co., Japan) under 10× magnification with DAPI filter.

Microbiology: The strain Pseudomonas aeruginosa PAO1 containing a stably integrated, GFP gene under a constitutive promoter (pTdK-GFP) was used for the colonization/biofilm assays based on the method of De Kievit et al. Briefly, an overnight culture of P. aeruginosa grown in TSB was adjusted to an OD₆₀₀ of 1.0, and diluted 1:1,000 in FAB medium (0.1 mM CaCl₂, 0.01 mM Fe-EDTA, 0.15 mM (NH₄)SO₄, 0.33 mM Na₂HPO₄, 0.2 mM KH₂PO₄, 0.5 mM NaCl, 0.5% (wt/vol) casamino acids, 1 mM MgCl₂, 10 mM sodium citrate) for the working bacterial solution. Each polymer coated coverslip was sterilized with a 70% ethanol solution and drying in a sterile 24-well culture plate. Negative controls demonstrated that this method of sterilization did not inhibit downstream assays (data not shown). Sterile, polymer coated coverslips were then inoculated with 2 mL of bacterial solution and incubated at 37° C. for 5 hours, rinsed gently in FAB media (3×) to remove non-adhered bacteria, imaged on a IX51 Epifluorescence Microscope (Olympus Co., Japan), under 10× magnification with 1 μL, of 20 mM propidium iodide used as an indicator of cell death. In order to determine both the number of attached cells and cell viability, cell coverage was calculated using Image J software on five random fields-of-view.

Bactericidal plating assay: The bactericidal activities of polymeric coatings were evaluated with overnight broth culture of bacteria adjusted to yield approximately 1×10⁹ CFU/ml. The polymer coated coverslips were placed into a 12 well plate and 2 mL of bacteria broth was added to each well plate and kept in the incubator at 37° C. for 24 hours. Then, 1 mL of bacteria solution was taken from each well plate and serially diluted in sterile TSB (pH 7.4) and spread onto TSA plates and were incubated at 37° C. to determine the number of colony forming units (CFus). All determinations were performed in triplicate including the growth controls.

Disk diffusion assay: 100 μL of overnight broth cultures adjusted to yield approximately 1×10⁹ CFU/ml was spread onto TSA plates. The polymer coated coverslips were placed on the inoculated agar surface and incubated at 37° C. 24 h. All tests were performed in triplicate and the antibacterial activity was expressed as the mean of inhibition diameters (mm) produced by polymeric coatings

Hemolysis assay: All assays were performed using defibrinated sheep blood washed in 6-8 rinses of 150 mM NaCl, phosphate buffered saline (PBS; pH 7.4) by centrifugation at 500×g before diluting 1:50 in PBS for the red blood cell (RBC) working solution. The hemolysis assay was carried out by placing polymer coated coverslips into 12 well plates and inoculation with 2 mL of RBC solution at 37° C. for 1 hr. To measure cell lysis via hemoglobin release, the RBC solution was centrifuged at 500×g for 10 minutes with absorbance measured at 450 nm, and compared with a non-polymer (0%) and 1% Triton X-100 (100%) control. All determinations were performed in triplicate.

In vitro cytotoxicity: NIH-3T3 mouse embryonic fibroblast cells, were grown on sterilized glass coverslips coated with the polymers or a glass-only control at 5,000 cells/cm². Cells were grown in DMEM/10% fetal bovine serum (Hyclone) and 1% penicillin-streptomycin (10,000 U/mL, Thermo Fisher Scientific) at 37° C. in 5% CO₂. LIVE/DEAD staining for mammalian cells were performed on days 1 and 3 after seeding the cells onto the surface, using Calcein AM and ethidium homodimer-1 stains. 250 μL each of 2 μM calcein AM and 4 μM ethidium homodimer-1 were added to each well. After incubating the cells for 10-15 minutes, the well plate was removed and the cells were imaged on the IX51 Epifluorescence Microscope. All determinations were performed in triplicate.

Synthesis and characterization of coumarin polyesters. In this work, a series of functionalized coumarin polyester coatings were developed to test the effect of either carboxylic acid or amine pendant groups to prevent P. aeruginosa colonization on surfaces. The composition of the polyesters were chosen to optimize antimicrobial activity and stability of the polymer film over the testing period. The polyesters are designed with pendant groups (25 mole %) that mimic the side chains of aspartic acid (anionic) or lysine (cationic). The aromatic coumarin unit (75 mole %) in the polyester enables visualization of the coating and decreases delamination of the film. In addition, the fidelity of the polymer coating can be monitored by the fluorescence of the coumarin units.

Photoresponsive coumarin diol (3), protected carboxylic acid or amine monomers (6, 9) and succinic acid were polymerized by room temperature carbodiimide-mediated polyesterification. The resultant protected carboxylic acid polyester (C—CO₂—P) and protected amine polyester (C—NH₂—P), were deprotected to provide anionic carboxylic acid (C—COO₂⁻) and cationic amine (C—NH₃) polyesters (Scheme 1). These polymers were characterized by ¹H NMR (Supporting information) and size exclusion chromatography (SEC) (Table 1). The number average molecular weight of the t-butyl protected carboxylic acid polyester (Mₙ=24 kDa) and Boc-protected amine polyester (Mₙ=28 kDa) are relatively similar allowing comparisons between the four polymers used in this study. As shown in Table 1, the glass transition temperature (T_{g}) for all polyesters range from 46.5° C. to 55.1° C. indicating that the different functional groups do not cause large differences in thermal properties of the polymers.

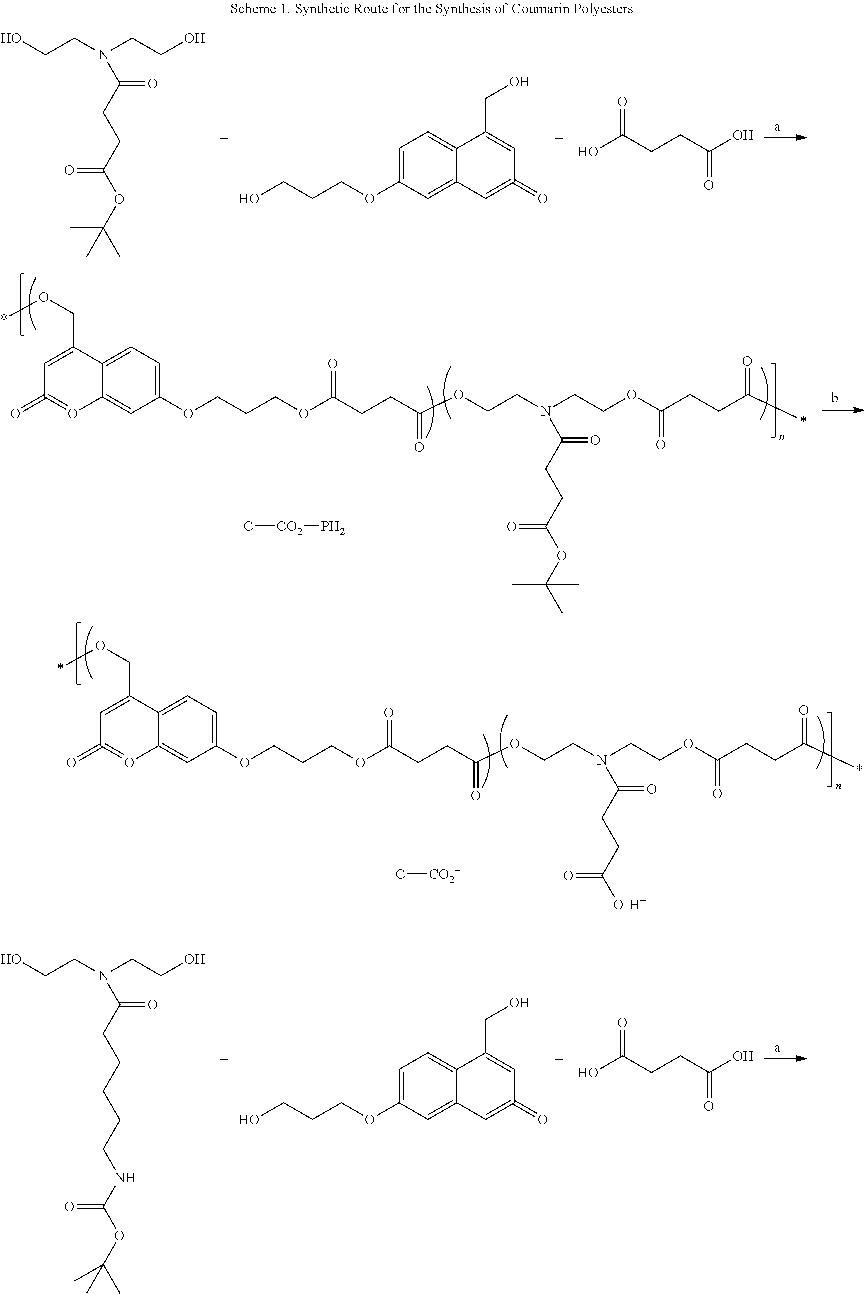

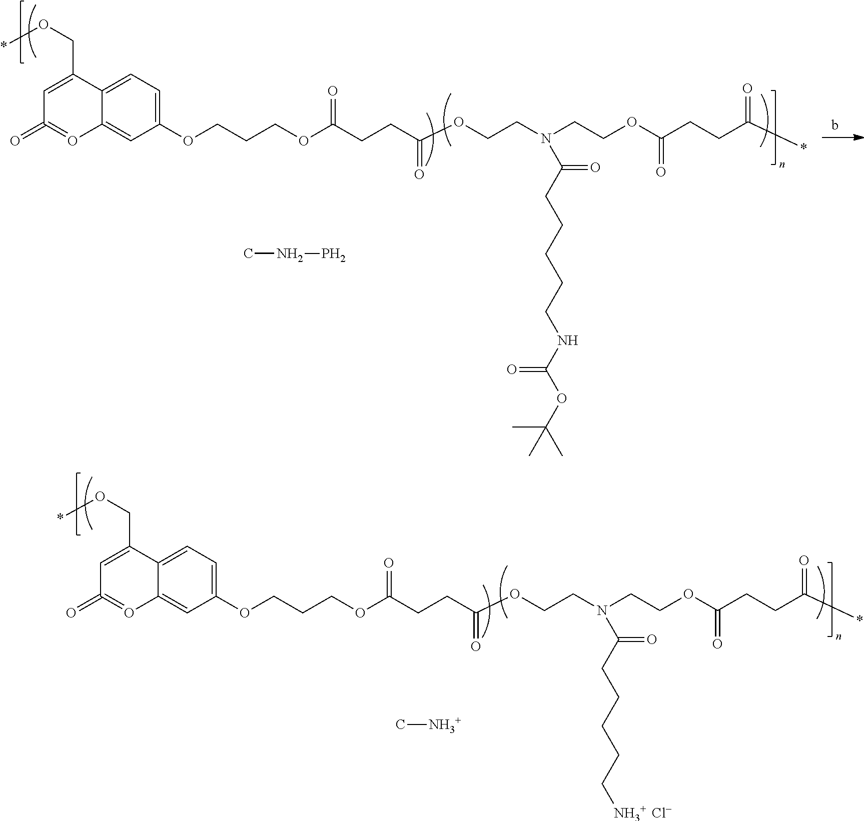

Reagents and conditions: a) DPTS/DIC/CH₂Cl₂/Room temperature, 48 h b) HCl/Dioxane/CH₂Cl₂, 45 minutes.

TABLE 1
Characterization of Coumarin Polyesters

| | Mₙ^{a} | M_{w}^{a} | | T_{g}^{b} | Thickness^{c} | Roughness^{d} |
|---|---|---|---|---|---|---|
| Polyester | (kDa) | (kDa) | [symbol] ^{a} | (° C.) | (nm) | (nm) |
| C—CO₂—P | 27.9 | 44.2 | 1.58 | 55.1 | 219.9 | 5.32 |
| C—CO₂⁻ | — | — | — | 51.5 | 112.4 | 5.8 |
| C—NH₂—P | 24.4 | 38.7 | 1.58 | 49.8 | 198.1 | 4.89 |
| C—NH₃⁺ | — | — | — | 46.5 | 113.3 | 5.21 |

^{a}Determined by DMF SEC relative to PMMA standards. [symbol]
= polydispersity index
^{b}Determined by DSC.
^{c}Determined by Ellipsometer.
^{d}Determined by AFM.

Polymer coating fabrication and characterization. The polymers were spin coated onto a glass coverslips and subsequently dried and annealed to provide homogenous thin coatings. The thickness of coatings was measured by ellipsometry and their surface roughness was evaluated by AFM. The thickness of the protected coatings (C—CO₂—P and C—NH₂—P) are in the range of 200 μm, while deprotected coatings (C—CO₂⁻ and C—NH₃⁺) are in the range of 100 μm (Table 1). In all cases the surface roughness, which indicates the deviation from uniform film thickness across the film surface, was measured between 4.8-5.8 nm, which is significantly less than the size of P. aeruginosa (0.5-0.8 μm×1.5-3.0 μm) and hence will not a significant factor in bacterial attachment on these films. The stability of the coatings was evaluated by incubation at 37° C. in phosphate buffered saline (PBS), pH 7.4, for a period of a month. As shown by the fluorescence of the coumarin moieties, both the non-crosslinked and crosslinked cationic amine coatings (C—NH₃⁺) were not substantially different from each other over this time period.

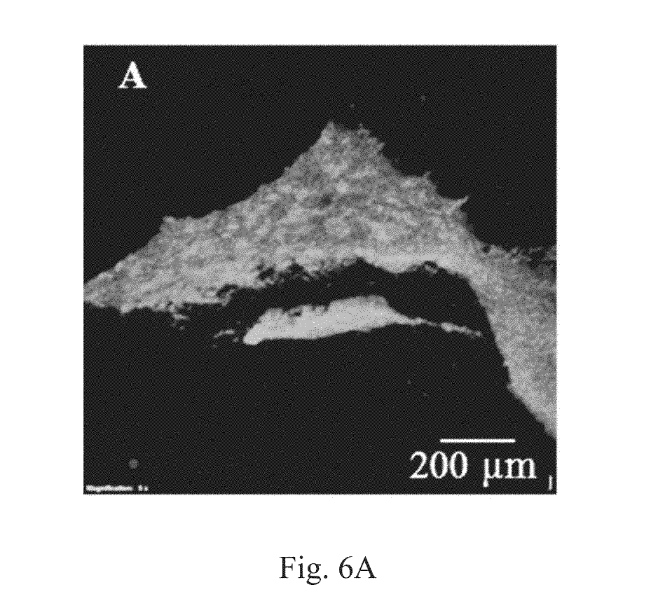

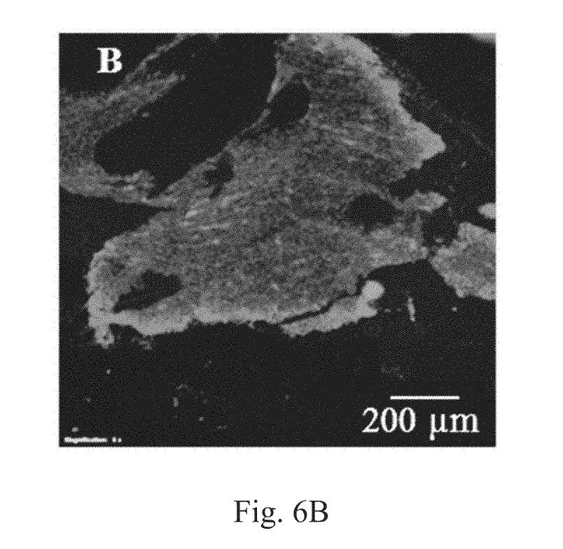

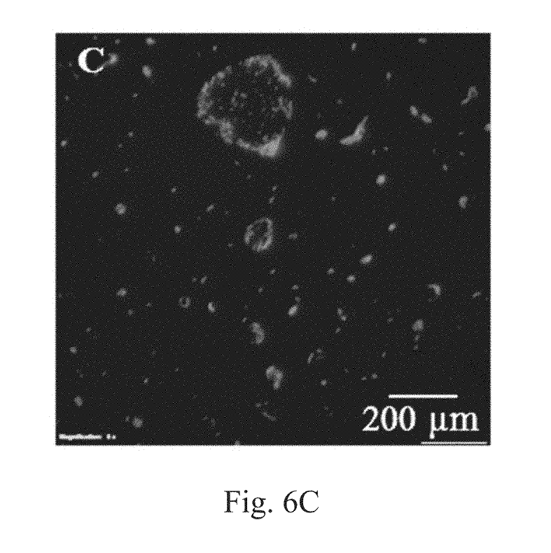

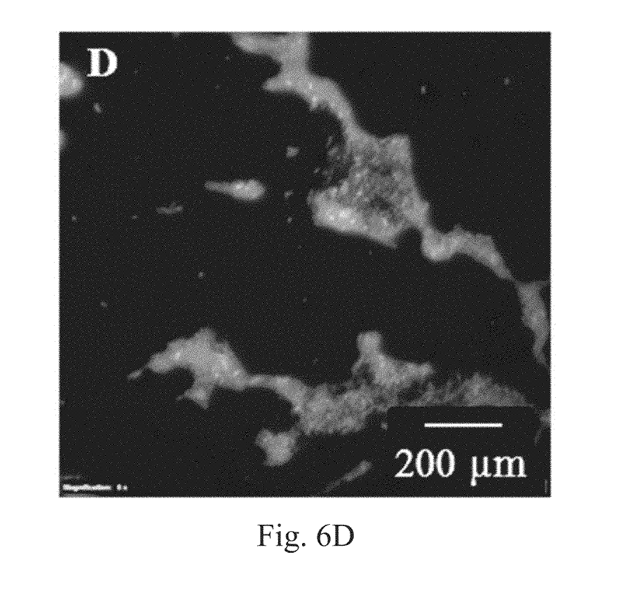

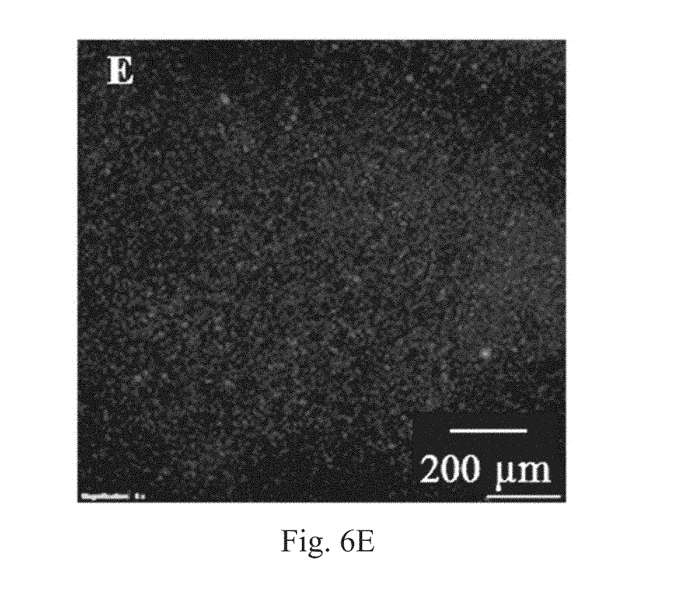

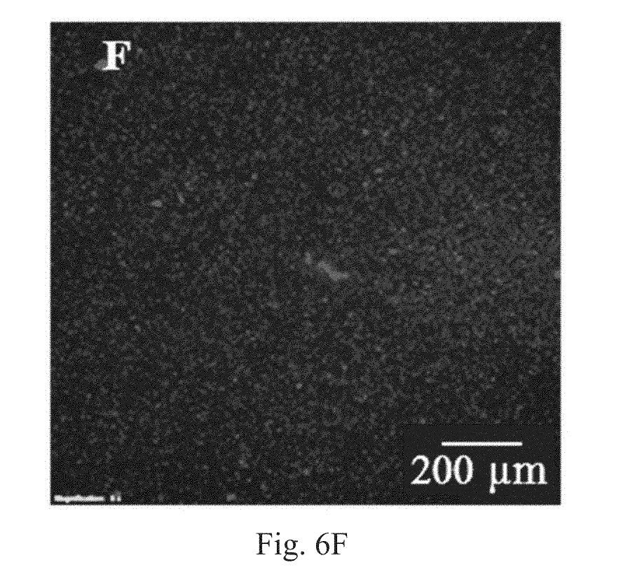

Inhibition of P. aeruginosa colonization on polymer coated surfaces. To determine the effect of chemical functionality on bacterial colonization on the surfaces, P. aeruginosa was plated onto the polymer coatings in static culture. After 5 h, bacterial colonization and viability were quantified by live/dead fluorescent microscopy. As shown in (FIG. 6A-F), there is a strong influence of cationic or anionic surface charge on the ability of P. aeruginosa to form biofilms and cell viability. The protected carboxylic acid polyester (C—CO₂—P) and the corresponding anionic carboxylic acid polyester (C—CO₂⁻) do not show a significant difference in the survival of P. aeruginosa; however, there were significantly less bacterial colonies on the anionic carboxylic acid surface compared to the protected carboxylic acid surface. Live/dead microscopy indicated that most of the attached bacteria were viable and retain the ability to form biofilm. P. aeruginosa is able to colonize the protected amine polyester (C—NH₂—P) surface and retains the ability to form biofilm, but more dead bacteria were observed on this surface relative to the carboxylic acid surfaces (FIG. 6A-F). In contrast to all the other surfaces, the cationic amine polyester (C—NH₃⁺) shows a remarkable ability to kill the attached P. aeruginosa cells, resulting in the absence of biofilm formation. Live/dead microscopy showed that there were no live bacteria and hence biofilm formation is not seen. The plating density was maintained at a high level so as to provide the bacteria maximum ability to survive under the experimental conditions. In order to test the influence of crosslinked coatings on bacterial attachment and biofilm formation, the cationic amine polyester (C—NH₃⁺) was crosslinked for 10 min, upon which the coumarin units undergo a [2+2]-photocycloaddition reaction to form cross-linked coatings. P. aeruginosa colonization on the crosslinked coatings showed very similar behavior to that of the non-crosslinked cationic amine polyester. On both the coatings there were no surviving bacteria and hence biofilm formation was not observed.

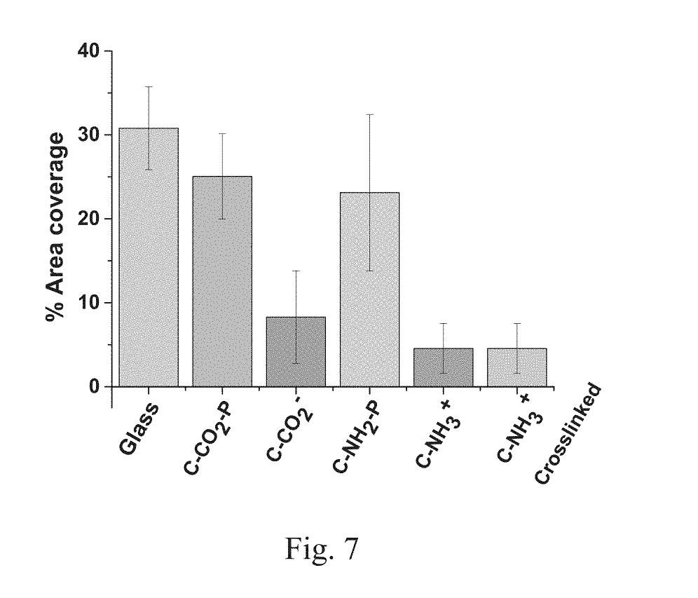

Amine containing polyesters are known to target bacterial cell surface due to the presence of negatively charged phospholipids. Calculated percentage area covered by bacteria on all the polymeric surfaces 5 h post-inoculation are shown in (FIG. 7). The percentage area covered on glass was 30.8±4.94. For C—CO₂—P and C—NH₂—P polyesters the percentage area covered was 25.1±5.08 and 23.1±9.31 respectively. In the case of deprotected polyesters, the percentage area covered for the anionic carboxylic acid polyester was 8.29±5.51 and 4.55±2.98 for cationic amine polyester. This observation concurs with literature showing lower bacterial adhesion on hydrophilic surfaces.

To understand the reason for P. aeruginosa survival and biofilm formation on the various polyester surfaces, the contact angles of the thin coatings were measured. All the surfaces show a decrease of contact angle with time, indicating polymer chain rearrangement upon contact with water. When the functional groups are protected, the C—CO₂—P and C—NH₂—P, surfaces have contact angles around 74°. The anionic carboxylic acid polyester (C—CO₂⁻) surface has a contact angle of 70°, while cationic amine polyester (C—NH₃⁺) surface has a lower contact angle of 60°. Interestingly, crosslinking of the cationic polyester coatings results in an increase in contact angle relative to the non-crosslinked cationic polyester, which could be explained by decreased mobility and availability of the NH₃⁺ groups on the polymer surface resulting in formation of a more hydrophobic surface. However, the surface energies of the various polyester coatings are not the reason for the ability of the amine containing polyesters to kill the attached bacteria and inhibit their ability to form biofilms. Both the crosslinked and non-crosslinked cationic amine polyesters show this ability although the crosslinked coatings have a higher contact angle than the non-crosslinked coatings. The protected carboxylic acid (C—CO₂—P), protected amine (C—NH₂—P) and anionic carboxylic acid (C—CO₂⁻) polyesters show contact angles in the same range as the crosslinked cationic amine polyester, but they do not exhibit the ability to kill the attached P. aeruginosa.

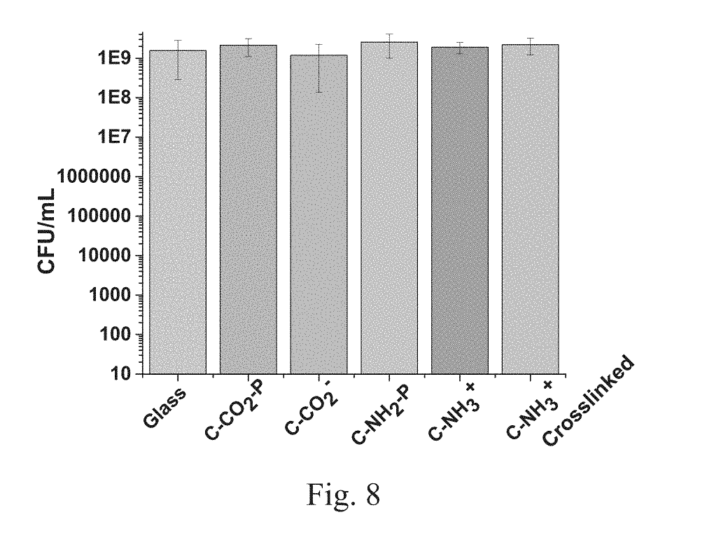

Bactericidal activity. In order to investigate if the antimicrobial activity of the cationic amine polyester coating is resulting from any residual small molecules or oligomers leaching out of the polymer coatings, the bactericidal activity of the various surfaces were evaluated by incubating bacteria in well plates containing polymer coated glass coverslips for 24 h. Subsequently bacteria from the supernatant were plated on agar plates and the colony forming units were counted. As shown in (FIG. 8), there is no significant bactericidal activity in any of the supernatant solutions, indicating the absence of any small molecules or oligomeric species leaching from the coatings. This shows that the bactericidal activity is only seen when P. aeruginosa comes in contact with the cationic amine polyester surface. In addition to the above experiment, a zone-of-inhibition study was carried out to eliminate the possibility of the anti-bacterial activity arising from bactericidal leaching from the polymer film. After 24 h of incubation, there was no discernible effect on bacterial growth and no observation of any zone-of-inhibition, confirming again the need for bacterial contact with the cationic surface for bactericidal activity.

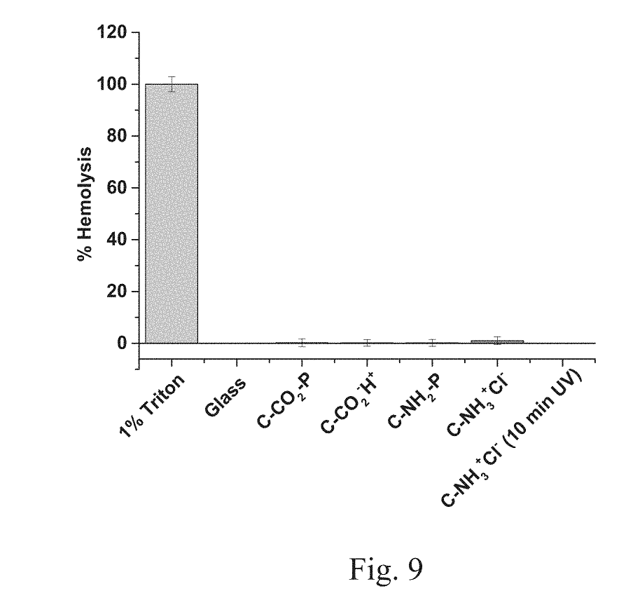

Hemolysis activity measurement. Hemolysis refers to the damage of red blood cells leading to the release of intracellular erythrocyte content into blood plasma. Therefore all medical devices and drugs that come into contact with blood need to be tested for potential hemolytic activity. In order to determine if the polymer surfaces are potentially harmful to the membranes of mammalian cells, we tested the polymer coatings for the ability to lyse red blood cells, which can be readily assayed by hemoglobin release. The hemolytic activity of the various polymer coatings were analyzed and compared to the known hemolysis agent, the surfactant Triton X-100 (FIG. 9). Interestingly all the coatings, had almost no hemolytic activity after treatment with red blood cells.

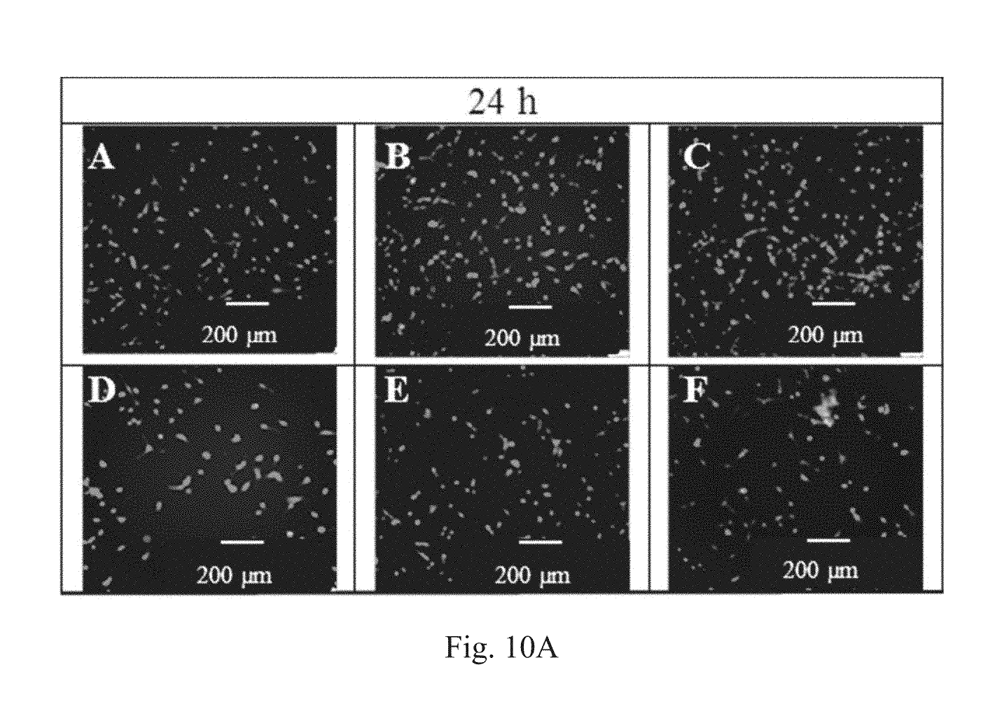

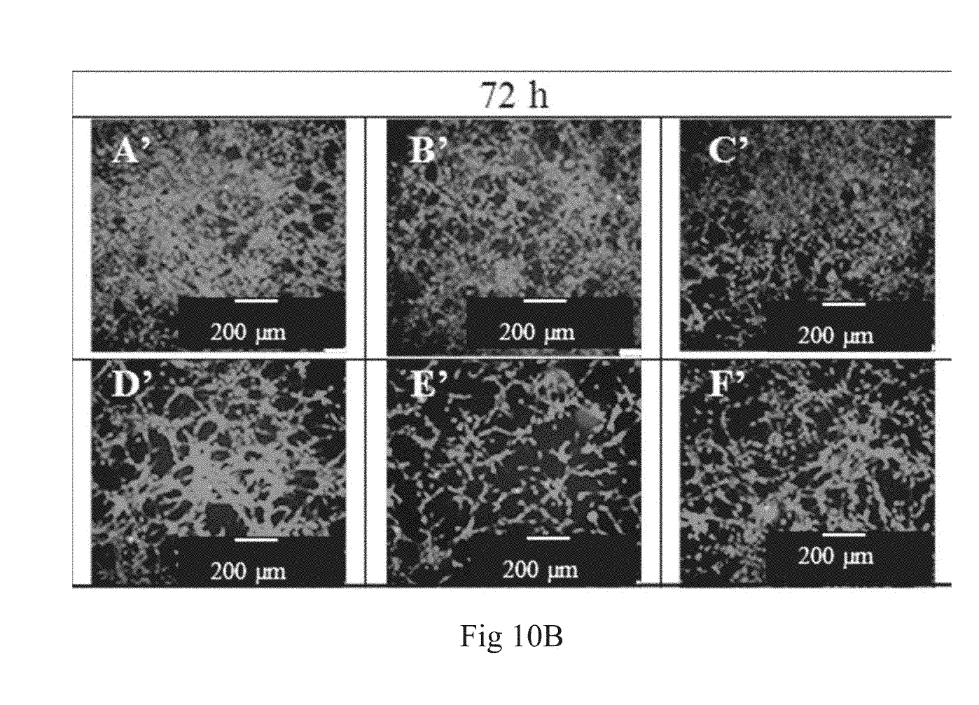

Cytotoxicity evaluation. Toxicity of the polymer coatings was evaluated toward NIH-3T3 cell growth on spin coated coverslips of the various polyesters after 24 h and 72 h. LIVE/DEAD staining was used to evaluate the viability of the cells. The polymeric coatings do not exhibit any observable cytotoxicity on NIH-3T3 mouse embryonic fibroblast cells after 24 and 72 hours study (FIGS. 10A and 10B). This is very significant in the case of the cationic polymers that show very high antimicrobial activity against P. aeruginosa, but do not have any observable cytotoxicity on NIH-3T3 mouse embryonic fibroblast cells. This selectivity is possibly due to the fact that the surfaces of bacteria possess more negative charges compared to mammalian cells, leading to stronger interactions between the cationic polyesters and the bacteria. The low toxicity could be a result of the relatively hydrophilic polyester backbone and lack of any pendant hydrophobic groups that can insert into the mammalian cell membranes.

1. A method for killing a microbial comprising:
introducing a functionalized amide polymer to a microbe, where the functionalized amide polymer includes
a polymer backbone selected from polyesters and polyurethanes;
an amide group with a pendant functional group, where the nitrogen atom of the amide group is part of the polymer backbone; and
a net positive charge.

2. The method of claim 1, where the functionalized amide polymer includes a unit defined by the formula: 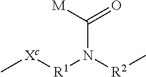
where each X^{c} is an ester group; R¹ and R² may be the same or different and are each hydrocarbon groups; and M is a cation containing functional group.

3. The method of claim 1, where the functionalized amide polymer includes a unit defined by the formula: 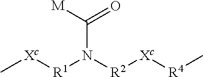
where each X^{c} is a urethane group or an ester group; R¹ and R² may be the same or different and are each hydrocarbon groups; R⁴ is a hydrocarbon group, and M is a cation containing functional group.

3. (canceled)

4. The method of claim 1, where the bacteria is gram negative.

5. The method of claim 1, where the bacteria is gram positive.

6. The method of claim 1, where the functionalized amide polymer is part of a coating composition.

7. The method of claim 1, where the functionalized amide polymer has a number average molecular weight from about 3,000 g/mol to about 45,000 g/mol.

8. The method of claim 1, where the functionalized amide polymer has a number average molecular weight from about 25,000 g/mol to about 200,000 g/mol

9. The method of claim 1, where the an amide groups with a pendant functional group of the functionalized amide polymer are from about 25% to about 50% cation containing functional groups.

10. The method of claim 1, where the functionalized amide polymer is defined by the formula 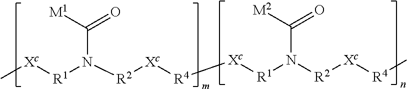
where every V is a urethane group or every V is an ester group; R¹ and R² may be the same or different and are each hydrocarbon groups; R⁴ is a hydrocarbon group; m is from about 4 to about 450 units, n is from about 1 to about 350 units, M¹ is a cationic charge containing pendant functional group, and M²is a pendant functional group.

11. The method of claim 1, where the functionalized amide polymer is defined by the formula 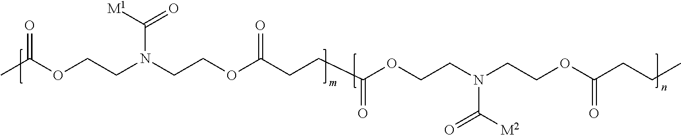
wherein m is from about 4 to about 450 units, n is from about 1 to about 350 units, M¹ is a cationic charge containing pendant functional group, and M²is a pendant functional group.

12. The method of claim 1, where the functionalized amide polymer is defined by the formula 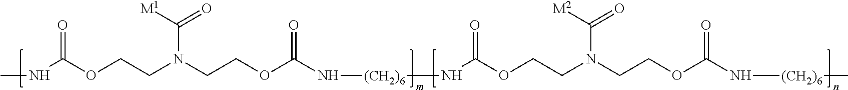
wherein m is from about 4 to about 450 units, n is from about 1 to about 350 units, M¹ is a cationic charge containing pendant functional group, and M²is a pendant functional group. In certain embodiments, m may be from about 4 to about 70.

13. The method of claim 1, where the functionalized amide polymer is defined by the formula 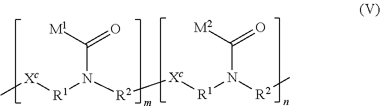
where every X^{c} is an ester group; R¹ and R² may be the same or different and are each hydrocarbon groups; m is from about 4 to about 450 units, n is from about 1 to about 350 units, M¹ is a cation containing pendant functional group, and M² is a pendant functional group.

14. The method of claim 1, where the functionalized amide polymer is defined by the formula 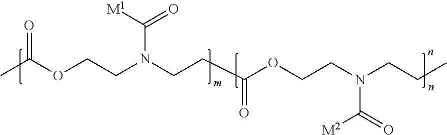
wherein m is from about 4 to about 450 units, n is from about 1 to about 350 units, M¹ is a cation containing pendant functional group, and M² is a pendant functional group.

15. The method of claim 1, where the functionalized amide polymer is included in a pharmaceutical composition.

16. The method of claim 1, where the functionalized amide polymer is part of a nanoparticle

17. The method of claim 1, where the functionalized amide polymer is part of a fiber.

18. The method of claim 1, where the functionalized amide polymer is part of a mat.

19. The method of claim 1, where the functionalized amide polymer is water soluble

20. The method of claim 1, where the functionalized amide polymer is water insoluble.

21. The method of claim 1, where the microbe is bacteria.

22. The method of claim 1, where the functionalized amide polymer includes a unit defined by the formula: 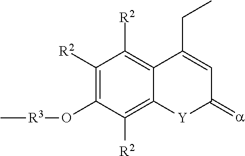
where each R² is individually a hydrogen atom, a bromine atom, an iodine atom, or a methoxy group; R³ is a hydrocarbon group; Y is an oxygen atom or a nitrogen atom with an organic substitution; and α is an oxygen atom or a sulfur atom.
